(19) United States
(12) Patent Application Publication
(10) Pub. No.: US 2006/0218266 A1
(43) Pub. Date: Sep. 28, 2006

(54) Centralized plant-monitoring controller and method

(75) Inventors: Seikai Matsumoto, Saitama (JP); Shinji Hayashi, Tokyo (JP); Kenji Oomori, Yamanashi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, TOKYO (JP)

(21) Appl. No.: 10/508,010

(22) PCT Filed: Mar. 26, 2003
(86) PCT No.: PCT/JP03/03711

§ 371 Date: Feb. 4, 2005

(30) Foreign Application Priority Data
Mar. 27, 2002 (JP) 2002-87631

(51) Int. Cl. G06F 15/173

(52) U.S. Cl. 709/224

(57) ABSTRACT

An information network which connects a centralized interactive unit for monitoring and controlling the operation of a plurality of plants and an individual interactive unit for monitoring and controlling a plant is connected to a control network which connects a control unit and the individual interactive unit by gateway means. The control unit multicasts a plant state quantity to the control network as a Tag if there is a significant change in the plant state quantity, and the centralized interactive unit and the individual interactive unit multicast a query about a plant state quantity to the control network and update a response from the control unit.

### TECHNICAL FIELD

The present invention relates to a centralized plant monitoring and controlling apparatus by individually controlling and monitoring the plants and by inputting information for monitoring and controlling each of the plants and also relates to a method therefor.

### BACKGROUND ART

Recent advances in communication technology are promoting the introduction of centralized monitoring and controlling apparatus for controlling the operation of a plurality of plants in a centralized manner in order to reduce the operating costs. For this purpose, a distributed control system (DCS) is employed to operate individual plants, and the operation of such plants is monitored with an industrial PC having a general-purpose OS, such as UNIX® or Windows®, installed therein to improve cost effectiveness. In this situation, connections based on general-purpose transmission units and protocols are assumed.

Furthermore, such a distributed control system (DCS) typically provides a mechanism in which a control unit and an interactive unit are used to acquire state quantities of plants and to operate component devices via an object called a Tag.

Normally, the TCP/IP communication protocol is employed for a programming model based on a client/server configuration. Thus, as a server plays a more important part, higher availability is required. This means that as the number of clients increases, higher arithmetic performance and transmission performance are required. Currently, a cluster structure is employed to ensure availability, and parallel processing is employed to ensure performance. In this case, not only does the cost of both hardware and software increase, but also the operation of the system becomes more complicated.

Multicast transmission technology based on UDP/IP, as opposed to TCP/IP, is also available. UDP/IP has a big advantage, for example, in that an increase in the number of clients does not directly affect the load on the server, though arrival of transmitted data is not guaranteed. For this reason, a mechanism for allowing a client to detect missing data and to make a request for retransmission of any missing data to the server is required. Thus, it is becoming more common to use TCP/IP and UDP/IP in combination to taking advantages of their respective features such that normal transmission is carried out by UDP/IP-based multicasting whereas retransmission of, for example, missing data is carried out by TCP/IP-based unicasting.

When the operation of a plurality of plants is to be monitored and controlled in a centralized manner, the amount of information to be manipulated increases in proportion to the number of plants to be monitored and controlled. Thus, it is necessary to overcome a problem of the load inevitably increasing and the performance inevitably decreasing at higher layers of the network hierarchy. Furthermore, since the network and servers need to be redundantized to increase the availability, a mechanism for ensuring the independence of clients from dynamic changes in the configuration is required.

In addition, when the state quantities of Tags to be monitored by distributed control systems (DCS) are input to and output from a centralized monitoring and controlling apparatus, the information and the format for transmission/reception must be agreed upon in advance with the distributed control systems (DCS) and such information must be preset in both transmitters and receivers. This information is fixed information which is set at the time of installation, and once such information is set, it is difficult to take a flexible action in response to any modifications or changes in operational utilization after the installation. Furthermore, a centralized monitoring and controlling apparatus has the burden of building a database, more specifically, the burden of setting and associating Tag information of each distributed control system (DCS) in a Tag database of its own.

In view of the defects or problems described above, an object of the present invention is to provide a centralized monitoring and controlling apparatus which exhibits highly responsive transmission even when the operation of many plants is monitored and controlled using many clients, functioning as interactive display units.

Another object of the present invention is to provide a centralized plant monitoring and controlling apparatus flexible enough to take an appropriate action in response to an increased number of plants to be monitored so that high reliability can be achieved.

Still another object of the present invention is to provide a method for centrally monitoring and controlling a plurality of plants using the above-described centralized plant monitoring and controlling apparatus.

### DISCLOSURE OF THE INVENTION

To achieve the above-described and other objects, an apparatus for centrally monitoring and controlling plants according to the present invention includes a centralized interactive unit for monitoring and controlling the operation of a plurality of plants; an individual interactive unit for monitoring and controlling a plant; an information network for connecting the centralized interactive unit and the individual interactive unit; a control unit for controlling a plant; a control network for connecting the control unit and the individual interactive unit; and gateway means which is disposed in the individual interactive unit and includes a transmission function equivalent to the control unit from the viewpoint of the individual interactive unit,

wherein the control unit includes means for inputting a state quantity of a plant as a Tag into a Tag database; means for multicasting a significant change in the state quantity of the plant to the control network or multicasting a “heartbeat” indicating the integrity thereof to the control network if there is no significant change in the state quantity of the plant; and means for returning the content of the Tag database in response to a query about the state quantity input from the control network and updating the content of the Tag database in response to an operation,

wherein the individual interactive unit includes means for displaying the state quantity of a Tag on an interactive screen of a plant if the Tag defined on the interactive screen exists in the Tag database of the individual interactive unit itself; means for multicasting a query about the state quantity to the control network if the Tag defined on the interactive screen does not exist in the Tag database of the individual interactive unit itself and for registering a response from the control unit in the Tag database for update; and means for setting a Tag included in the control unit as defective if a “heartbeat” indicating the integrity of the control unit is not received from the control unit for a particular period of time, and

wherein the centralized interactive unit includes means for displaying the state quantity of a Tag on an interactive screen of a plant if the Tag defined on the interactive screen exists in the Tag database of the centralized interactive unit itself; means for multicasting a query about the state quantity to the control network via the information network and the gateway means if the Tag defined on the interactive screen does not exist in the Tag database of the centralized interactive unit itself and for registering a response from the control unit in the Tag database for update; and means for setting a Tag included in the control unit as defective if a “heartbeat” indicating the integrity of the control unit is not received from the control unit for a particular period of time.

In the apparatus for centrally monitoring and controlling plants having the above-described features, the information network which connects the centralized interactive unit for monitoring and controlling the operation of a plurality of plants and the individual interactive unit for monitoring and controlling a plant is connected to the control network which connects the control unit and the individual interactive unit by the gateway means. The control unit multicasts a plant state quantity to the control network as a Tag if there is a significant change in the plant state quantity, and the centralized interactive unit and the individual interactive unit multicast a query about a plant state quantity to the control network and update a response from the control unit. Thus, the centralized interactive unit connected to the information network recognizes the individual interactive unit as the control unit, and hence a multi-layered construction can be achieved.

In an preferred embodiment of the present invention, the individual interactive unit may include a security database storing information for restricting a monitorable and operable range for each operator and the gateway means may restrict the simulation range of the control unit based on a definition in the security database.

According to this embodiment, the gateway means of the individual interactive unit restricts the simulation range of the control unit based on the definition in the security database. Consequently, the monitoring and operating range can be restricted according to the level and the operation area of the operator, and hence the number of operator's incorrect operations can be reduced. Furthermore, since only the information required by the operator is transmitted, the load on the information network and the control network can be lessened.

Furthermore, the information network, the control network, the control unit, the centralized interactive unit, and the individual interactive unit may be redundantized such that the control unit, the centralized interactive unit, and the individual interactive unit perform multicast transmission to all redundantized information networks and control networks and perform reception of one processing unit at a time on a first-come-first-served basis.

According to this embodiment, the redundantized control units, centralized interactive units, and individual interactive units carry out multicast transmission to all redundantized information networks and control networks and perform reception of one processing unit at a time on a first-come-first-served basis. As a result, the centralized interactive unit functioning as a client recognizes a responder to a multicast query as a server. Thus, it is not necessary to recognize in advance the unicast address and the multiplicity of the control unit and the individual interactive unit functioning as servers. This allows for reconfiguration without interrupting the current operational utilization.

The centralized interactive unit or the individual interactive unit may include memory management means for deleting a Tag in the Tag database if no reference is made to the Tag for a particular period of time.

According to this embodiment, if a reference is not made to a Tag in the Tag database for a certain period of time, the memory management means of the centralized interactive unit or the individual interactive unit deletes the Tag. As a result, Tags not needed by clients and Tags referred to less frequently can be ruled out of a query resulting from missing notification of a change in state quantity of a plant. This lessens the load on the information network and control network.

The individual interactive unit may include as the Tag database a local Tag database for storing a Tag requested by the individual interactive unit itself and a remote Tag database for storing a Tag requested by the gateway means.

According to this embodiment, the individual interactive unit stores a Tag requested by the individual interactive unit itself in the local Tag database, and stores a Tag requested by the gateway means in the remote Tag database. As a result, client-by-client reference can be managed to reduce unnecessary notification and to lessen the load on the information network and control network.

The centralized interactive unit may output a registration request specifying a Tag required for monitoring to the individual interactive unit and the individual interactive unit may store the Tag whose registration is requested by the centralized interactive unit in a Tag list and convert and transmit the state quantity of the Tag stored in the Tag list by the gateway means in accordance with the format of the centralized interactive unit.

According to this embodiment, the centralized interactive unit outputs a registration request specifying a Tag required for monitoring to the individual interactive unit. By the gateway means, the individual interactive unit converts and transmits the state quantity of a Tag whose registration is requested by the centralized interactive unit in accordance with the format of the centralized interactive unit. As a result, the control unit in a plant can be connected easily, and hence Tags can be added or deleted flexibly in response to a change in operational utilization.

In the above-described embodiment, the centralized interactive unit may output a request for updating Tag information in the control unit to the individual interactive unit, the individual interactive unit may transmit the Tag information in the control unit whose updating is requested by the centralized interactive unit, and the centralized interactive unit may add a unique identification ID to the received Tag information and store the Tag information in accordance with the format of the centralized interactive unit.

In this case, the centralized interactive unit outputs a request for updating the Tag information of the control unit to the individual interactive unit. The individual interactive unit transmits the Tag information of a Tag to be monitored whose updating is requested to the centralized interactive unit. The centralized interactive adds a unique identification ID to the received Tag information and stores the Tag information in accordance with the format of the centralized interactive unit. This enables the Tag information of a Tag to be monitored that has been registered from the centralized interactive unit can be identified and hence obtained from the individual interactive unit. Consequently, the Tag database in the centralized interactive unit can be constructed easily or automatically.

A GW unit in place of the individual interactive unit may include only a transmission function equivalent to the control unit for the centralized interactive unit.

The GW unit in this example does not include the plant interactive screen and interactive unit in the individual interactive unit from the effect of this embodiment. Because of this, the cost and space associated with the installation of the GW unit not required for interactive operation in normal centralized monitoring can be reduced.

Furthermore, to achieve the above-described objects, a method for centrally monitoring and controlling a plurality of plants is provided by using an apparatus for centrally monitoring and controlling plants that includes a centralized interactive unit for monitoring and controlling the operation of a plurality of plants; an individual interactive unit for monitoring and controlling a plant; an information network for connecting the centralized interactive unit and the individual interactive unit; a control unit for controlling a plant; a control network for connecting the control unit and the individual interactive unit; and gateway means which is disposed in the individual interactive unit and includes a transmission function equivalent to the control unit from the viewpoint of the individual interactive unit,

wherein the control unit carries out the steps of inputting a state quantity of a plant as a Tag into a Tag database; multicasting a significant change in the state quantity of the plant to the control network or multicasting a “heartbeat” indicating the integrity thereof to the control network if there is no significant change in the state quantity of the plant; and returning the content of the Tag database in response to a query about the state quantity input from the control network and updating the content of the Tag database in response to an operation,

wherein the individual interactive unit carries out the steps of displaying the state quantity of a Tag on an interactive screen of a plant if the Tag defined on the interactive screen exists in the Tag database of the individual interactive unit itself; multicasting a query about the state quantity to the control network if the Tag defined on the interactive screen does not exist in the Tag database of the individual interactive unit itself and registering a response from the control unit in the Tag database for update; and setting a Tag included in the control unit as defective if a “heartbeat” indicating the integrity of the control unit is not received from the control unit for a particular period of time, and

wherein the centralized interactive unit carries out the steps of displaying the state quantity of a Tag on an interactive screen of a plant if the Tag defined on the interactive screen exists in the Tag database of the centralized interactive unit itself; multicasting a query about the state quantity to the control network via the information network and the gateway means if the Tag defined on the interactive screen does not exist in the Tag database of the centralized interactive unit itself and registering a response from the control unit in the Tag database for update; and setting a Tag included in the control unit as defective if a “heartbeat” indicating the integrity of the control unit is not received from the control unit for a particular period of time.

The above-described features and structures and other features and structures of the present invention will be described hereunder in more detail with reference to the accompanying drawings.

### BRIEF DESCRIPTION OF THE DRAWINGS

FIG. 1 is a block diagram of a centralized plant monitoring and controlling apparatus according to a first embodiment of the present invention.

FIG. 2 is a detailed block diagram of the centralized plant monitoring and controlling apparatus according to the first embodiment of the present invention shown in FIG. 1.

FIG. 3 is an illustration of a transmission scheme used by a centralized plant monitoring and controlling apparatus according to the first embodiment of the present invention.

FIG. 4 is a schematic diagram for illustrating a Tag database of a centralized plant monitoring and controlling apparatus according to the first embodiment of the present invention.

FIG. 5 is an illustration of a Tag database in each control unit, an individual interactive unit having gateway means, and a centralized interactive unit according to the first embodiment of the present invention.

FIG. 6 is an illustration of information included in response request content signals according to a transmission scheme employed by a centralized plant monitoring and controlling apparatus according to the first embodiment of the present invention.

FIG. 7 is a flowchart showing the processing of a database reference by Tag database input/output means according to the first embodiment of the present invention.

FIG. 8 is a flowchart showing the processing of a “heartbeat” HB, a reply R, and an exception E by transmission means according to the first embodiment of the present invention.

FIG. 9 is a flowchart showing processing by garbage collection means according to the first embodiment of the present invention.

FIG. 10 is a schematic block diagram of a source database according to the first embodiment of the present invention.

FIG. 11 is a flowchart showing processing by transfer means in a control unit according to the first embodiment of the present invention.

FIG. 12 is a flowchart showing processing by gateway means in an individual interactive unit according to the first embodiment of the present invention.

FIG. 13 is a detailed block diagram of a centralized plant monitoring and controlling apparatus according to a second embodiment of the present invention.

FIG. 14 is a schematic block diagram of a security database according to the second embodiment of the present invention.

FIG. 15 is a schematic block diagram of a Tag database according to the second embodiment of the present invention.

FIG. 16 is a block diagram of a centralized plant monitoring and controlling apparatus according to a third embodiment of the present invention.

FIG. 17 is an illustration of a transmission scheme employed by a plant centralized monitoring and controlling apparatus according to the third embodiment of the present invention.

FIG. 18 is a flowchart showing the processing of a database reference DB by Tag database input/output means in a centralized plant monitoring and controlling apparatus according to the third embodiment of the present invention.

FIG. 19 is a flowchart showing the processing of a “heartbeat” HB, a reply R, and an exception E by Tag database input/output means 14 from transmission means according to the third embodiment of the present invention.

FIG. 20 is a schematic block diagram of a Tag database in a centralized plant monitoring and controlling apparatus according to a fourth embodiment of the present invention.

FIG. 21 is a flowchart showing processing by Tag database input/output means according to the fourth embodiment of the present invention.

FIG. 22 is a flowchart showing the processing of a “heartbeat” HB, a reply R, and an exception E by transmission means according to the fourth embodiment of the present invention.

FIG. 23 is a flowchart showing processing by garbage collection means according to the fourth embodiment of the present invention.

FIG. 24 is a detailed block diagram of a centralized plant monitoring and controlling apparatus according to a fifth embodiment of the present invention.

FIG. 25 is a flowchart showing processing by Tag database input/output means according to the fifth embodiment of the present invention.

FIG. 26 is a flowchart showing the processing of a “heartbeat” HB, a reply R, and an exception E by transmission means according to the fifth embodiment of the present invention.

FIG. 27 is a detailed block diagram of a centralized plant monitoring and controlling apparatus according to a sixth embodiment of the present invention.

FIG. 28 is a detailed block diagram of a centralized plant monitoring and controlling apparatus according to a seventh embodiment of the present invention.

FIG. 29 is a detailed block diagram of a centralized plant monitoring and controlling apparatus according to an eighth embodiment of the present invention.

### BEST MODE FOR CARRYING OUT THE INVENTION

Embodiments according to the present invention will be described hereunder with reference to the accompanying drawings.

### First Embodiment

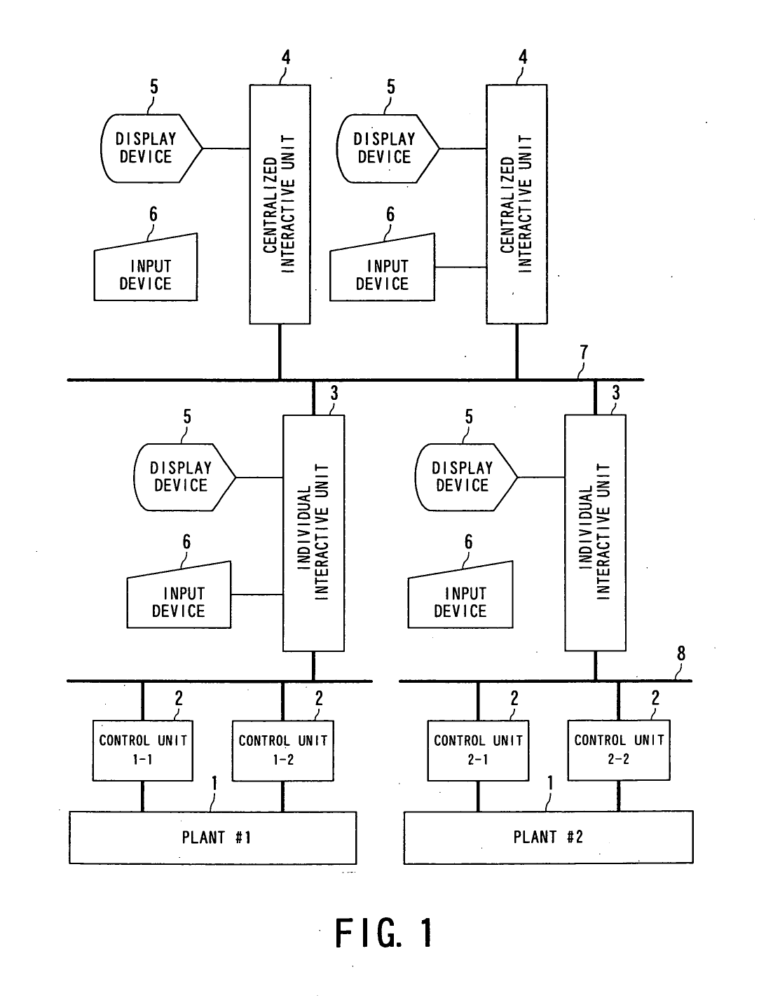

FIG. 1 is a block diagram of a centralized plant monitoring and controlling apparatus according to a first embodiment of the present invention. Plant state quantities, such as temperature, pressure, flow rate, and valve open/close status, collected from a plant 1 are input to a control unit 2 and subjected to control and arithmetic operations. The result of arithmetic operations is output to the plant 1 as the amount of control. Furthermore, plant state quantities from the control unit 2 are output to a control network 8 by multicast transmission (e.g., UDP/IP) as Tags. An individual interactive unit 3 inputs information regarding a plant to be monitored and controlled by that individual interactive unit 3 from the control network 8. The individual interactive unit 3 has a display device 5 and an input device 6 connected thereto, so that the operator can monitor and control each plant 1 with the individual interactive unit 3 via the display device 5 and the input device 6. It is noted that the hierarchical network shown in FIG. 1 shows a logical structure which can also be introduced with virtual LAN technology, and is not intended to restrict the physical structure.

Furthermore, the individual interactive unit 3 is connected to a centralized interactive unit 4 for monitoring and controlling a plurality of plants 1 in a centralized manner via an information network 7, and the individual interactive unit 3 includes gateway means for connecting the information network 7 and the control network 8. The individual interactive unit 3 including the gateway means transfers plant state quantities output to the control network 8 to the information network 7 by multicast transmission. The centralized interactive unit 4 inputs the state quantities output to the control network 8 or the information network 7, and displays and updates the interactive screen of the display device 5, including the plant state quantities, selected and requested by the operator using the input device 6, so that the operator can monitor and control the plant.

The individual interactive unit 3 and the centralized interactive unit 4 according to the present invention can be regarded as a lower-level interactive display unit and a higher-level interactive display unit, respectively.

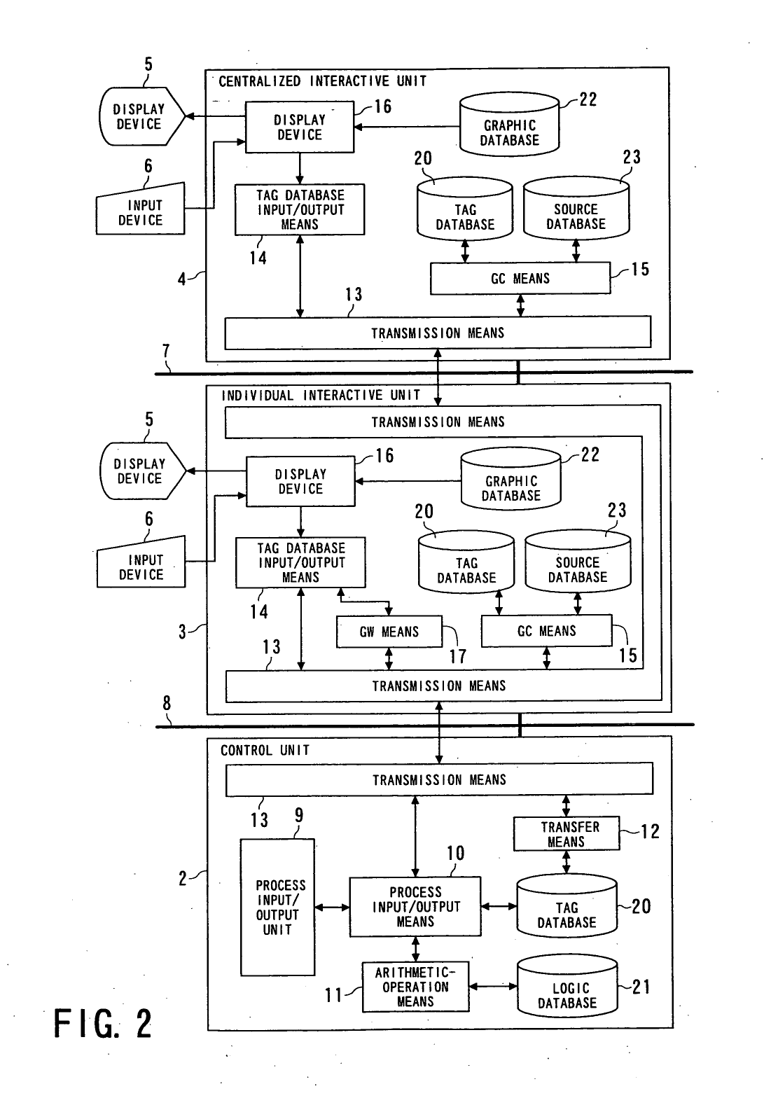

FIG. 2 is a detailed block diagram of the centralized plant monitoring and controlling apparatus according to the first embodiment of the present invention shown in FIG. 1. The control unit 2 includes a logic database 21 for controlling the plant 1 and a Tag database 20 for storing plant state quantities as Tags, inputs a process signal from the plant by process input/output means 10 via a process input/output unit 9, and carries out control and arithmetic operations by arithmetic-operation means 11. The control unit 2 then outputs the result of arithmetic operations to the plant 1 via the process input/output unit 9 by the process input/output means 10.

More specifically, the process input/output means 10 successively inputs state quantities of the plant 1 obtained from measuring points installed in the plant via the process input/output unit 9, and updates the state quantities of Tags to be monitored and operated in the Tag database 20. Furthermore, the process input/output means 10 outputs a significant change in state quantity by multicast transmission to the control network 8 via transmission means 13. In addition, the process input/output means 10 outputs the result of arithmetic operations output by the arithmetic-operation means 11 to the plant 1 and the control network 8.

The arithmetic-operation means 11 performs arithmetic operations of the arithmetic expression defined in the logic database 21 from the state quantities of the plant 1 obtained from the process input/output means 10, and outputs the result of arithmetic operations to the process input/output means 10.

The transmission means 13 not only outputs the output from the process input/output means 10 to the control network 8, but also outputs a query and operation associated with the state quantities input from the control network 8 to transfer means 12. The query and operation associated with the state quantities are output from the centralized interactive unit 4 and the individual interactive unit 3.

The transfer means 12 responds to a query output from the transmission means 13 with the content of the Tag database 20, and updates the content of the Tag database 20 in response to an operation. Furthermore, the transfer means 12 periodically outputs a “heartbeat” indicating the integrity of the control unit 2 to the control network 8.

The individual interactive unit 3 includes gateway means (GW means) 17 for connecting the information network 7 and the control network 8. The individual interactive unit 3 further includes a graphic database 22 for storing graphic data of the interactive screen, a Tag database 20 for storing as Tags plant state quantities to be monitored and controlled by that individual interactive unit 3, and a source database 23 for storing data indicating an information reception status.

Display means 16 reads out the interactive screen selected with the input device 6 from the graphic database 22 and outputs the interactive screen to the display device 5. Furthermore, the display means 16 inputs state quantities of Tags defined on the interactive screen from the Tag database 20 via Tag database input/output means 14, and updates and displays the state quantities on the interactive screen. When a Tag to which reference is made by the display means 16 exists in the Tag database 20, the Tag database input/output means 14 outputs the state quantity of the Tag, or otherwise outputs a query about the state quantity to the control network 8 via the transmission means 13. A response to the query output by the transfer means 12 of the control unit 2 is then updated by registration in the Tag database 20, and a change in process status output by the process input/output means 10 is updated in the Tag database 20. Furthermore, memory management means 15 (hereinafter, referred to as garbage collection means 15), serving as a memory management function, sets Tags included in the control unit 2 as defective if a “heartbeat” indicating the integrity of the control unit 2 is not received from the control unit 2 for a certain period of time.

The centralized interactive unit 4 has a structure similar to that of the individual interactive unit 3 except that the centralized interactive unit 4 does not include the gateway means 17. The centralized interactive unit 4 transmits and receives information to and from the control unit 2 via the gateway means 17 of the individual interactive unit 3.

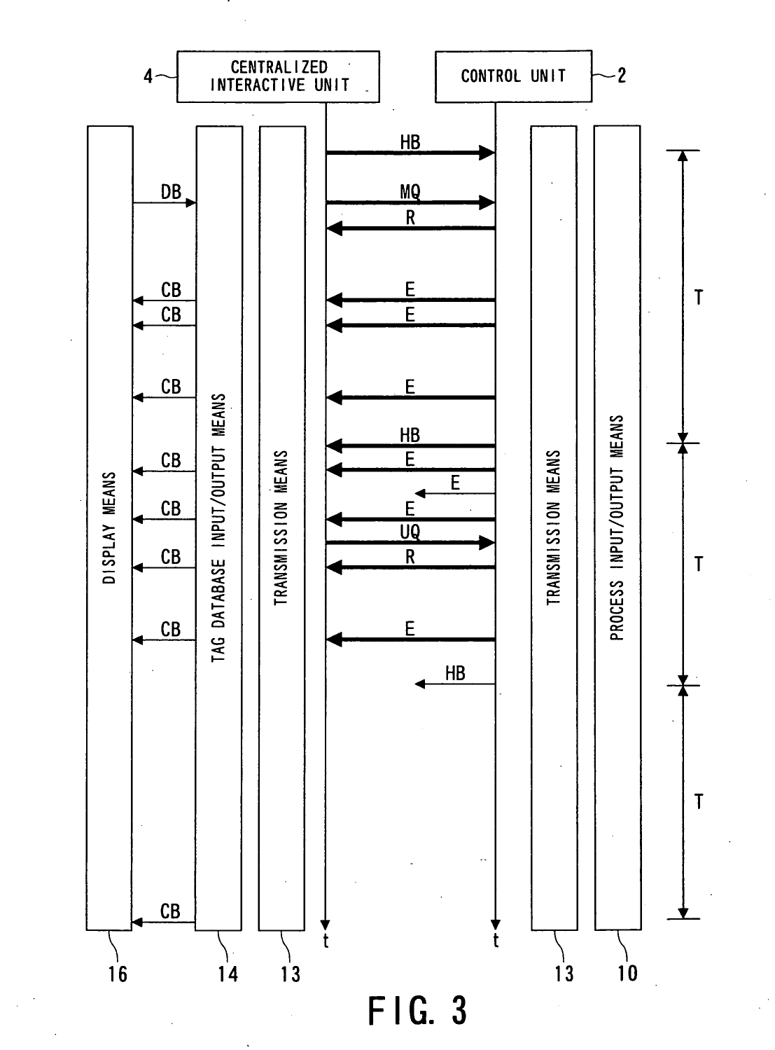

FIG. 3 is an illustration of the transmission scheme used by the centralized plant monitoring and controlling apparatus according to the first embodiment of the present invention shown in FIG. 2. FIG. 3 shows a transmission scheme between the control unit 2 and the centralized interactive unit 4. According to the present invention, due to the gateway means 17 provided, the transmission scheme between the centralized interactive unit 4 and the control unit 2 is basically equivalent to the transmission scheme between the individual interactive unit 3 and the control unit 2.

The display means 16 of the centralized interactive unit 4 outputs a database reference DB. More specifically, the display means 16 reads the interactive screen selected from the graphic database 22, generates a collection of Tags used on the screen, and then outputs a database reference DB to the Tag database input/output means 14.

The Tag database input/output means 14 reports a callback CB for a Tag registered in the Tag database 20, or outputs a multicast query MQ to the control network 8 via the information network 7 and the gateway means 17 for a Tag not registered in the Tag database 20.

The transfer means 12 of the control unit 2 connected to the control network 8 outputs a Tag registered in the Tag database 20 to the control network 8 as a reply R. In this case, the gateway means 17 of the individual interactive unit 3, which simulates the control unit 2, outputs what is registered in the Tag database 20 to the information network 7 as a reply R, or outputs a multicast query MQ to the control network 8 for what is not registered.

As a result of the above-described operation, a reply R in response to the multicast query MQ is transferred to the higher-level centralized interactive unit 4 or the individual interactive unit 3 from the control unit 2, and thereby a duplicate of the control unit 2 including the relevant Tag as an entity is produced in the Tag databases 20 of all interactive display units 3 and 4. Thus, as soon as notification of a callback CB to the display means 16 occurs, the control unit 2 in which the entity exists can be recognized.

A change in plant state quantity is output as an exception E by the control unit 2. The Tag database input/output means 14 in the centralized interactive unit 4 updates the Tag database 20 and outputs notification of a callback CB to the display means 16. Furthermore, the Tag database input/output means 14 in the centralized interactive unit 4 detects a loss of the exception E with the serial number set in the relevant exception E.

A content which is possibly lost can be compensated for by issuing a unicast query UQ (e.g., TCP/IP) for all Tags transmitted from the relevant control unit 2 and thereby obtaining a reply R. If a unicast query UQ cannot be issued, it means that the control unit 2 or the individual interactive unit 3 that simulates the control unit 2 has stopped its function. A multicast query MQ is output in order to make another search.

If no exception E is output, it means that there is no change in plant state quantity. Since it cannot be determined whether this situation results from the loss of the transmission function in the control unit 2, the control unit 2 periodically outputs a “heartbeat” HB indicating the integrity of the control unit 2 itself to the control network 8.

The garbage collection means 15 of the centralized interactive unit 4 regards as normal a situation where there is no output of exception E, as long as the “heartbeat” HB is periodically output. In other words, the garbage collection means 15 can recognize the loss of a function if the output of the “heartbeat” HB is not seen for several periods or more.

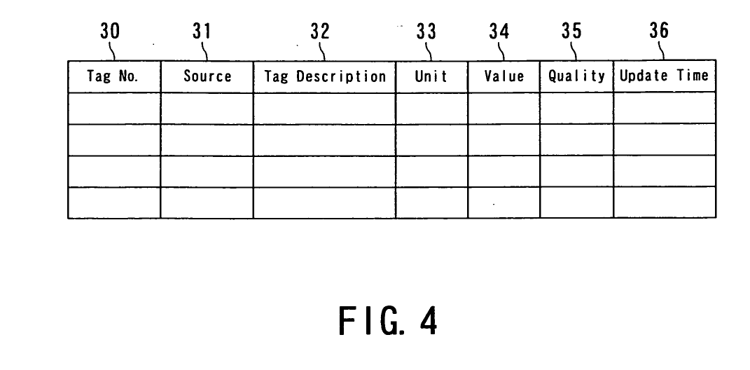

FIG. 4 is a schematic diagram for illustrating the Tag database 20 of the centralized plant monitoring and controlling apparatus according to the first embodiment of the present invention shown in FIG. 2. Tag database 20 includes a Tag NO. 30, a source 31, a Tag description 32, an engineering unit 33, a current value 34, a quality 35, and an update timestamp 36 to store these items of information about a Tag. The source 31 is a unique identifier assigned to the control unit 2 or the individual interactive unit 3 simulating the control unit 2.

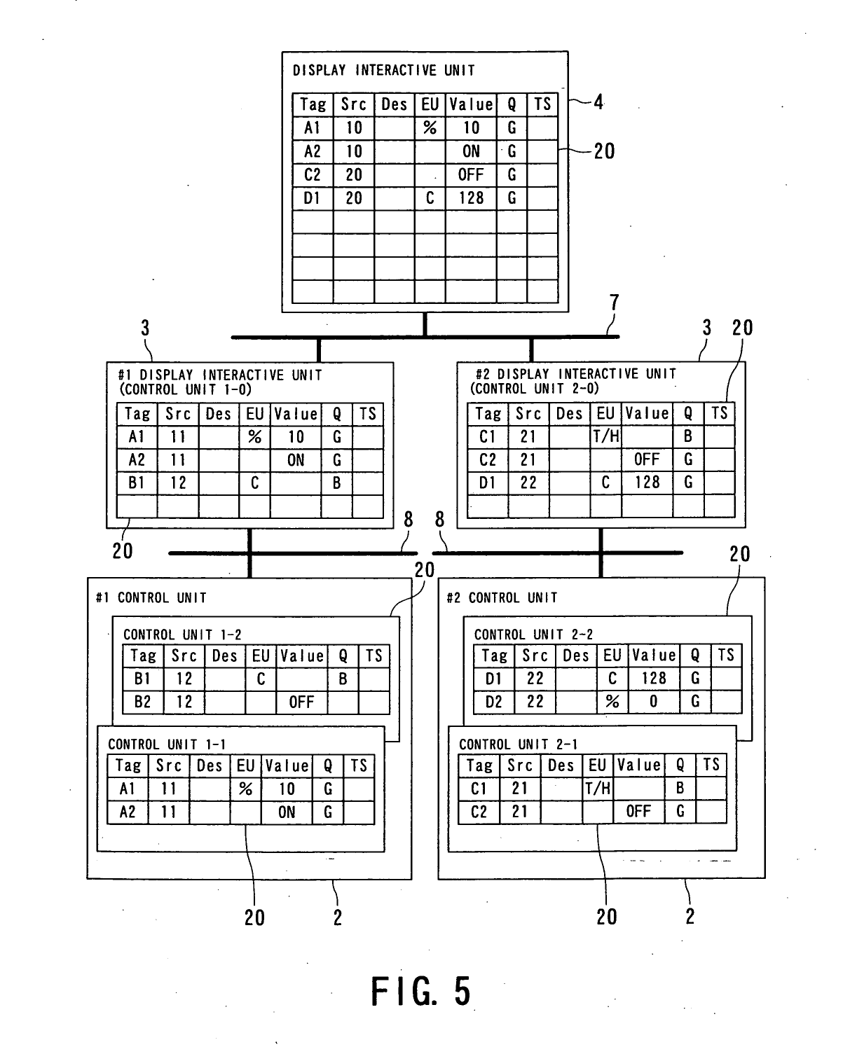

FIG. 5 shows the content of the Tag database 20 with the structure shown in FIG. 4 as applied to each control unit 2, the individual interactive unit 3 having the gateway means 17, and the centralized interactive unit 4.

In the Tag database 20 of the control unit 2, the state quantities of all Tags defined are retained and are continuously updated by the process input/output means 10. In the individual interactive unit 3 and the centralized interactive unit 4 connected to the control network 8 and the information network 7, duplicates of what is required by the display means 16 thereof are retained. For example, in the individual interactive unit 3 connected to the information network 7, duplicates of what is required by the display means 16 of the individual interactive unit 3 and the display means 16 of the centralized interactive unit 4 are retained, and in the centralized interactive unit 4, duplicates of what is required by the display means 16 of the centralized interactive unit 4 are retained.

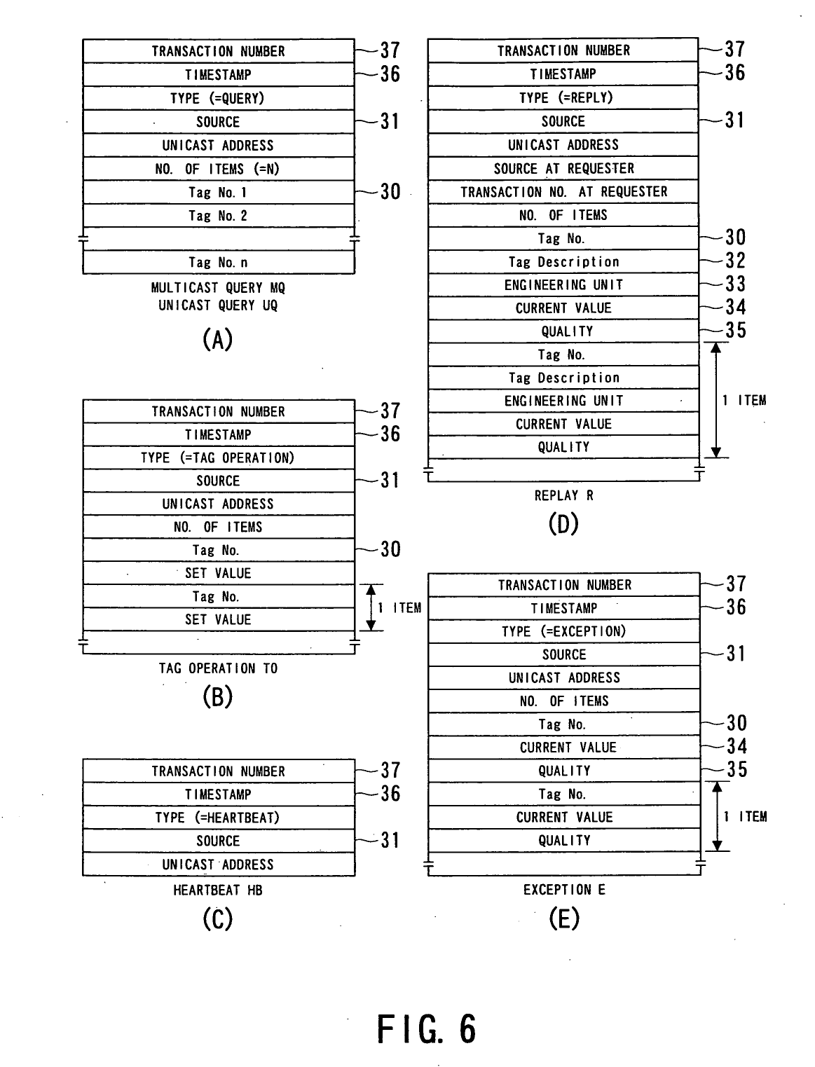

FIG. 6 is an illustration of information included in the response request content signals, shown in FIG. 3, according to the transmission scheme employed by the centralized plant monitoring and controlling apparatus according to the first embodiment of the present invention. FIG. 6(A) shows the content of a multicast query MQ or unicast query UQ, FIG. 6(B) shows the content of a Tag operation TO, FIG. 6(C) shows the content of a “heartbeat” HB, FIG. 6(D) shows the content of a reply R, and FIG. 6(E) shows the content of an exception E.

In FIG. 6(A), the multicast query MQ or the unicast query UQ includes a transaction number 37 indicating a processing unit, a timestamp 36, a type, a source 31, a unicast address, the number of items, and a Tag NO. 30. A query is described in the type. In FIG. 6(B), the Tag operation TO includes a transaction number 37, a timestamp 36, a type, a source 31, a unicast address, a Tag NO. 30, and a set value. In the type, the Tag operation is described, and the Tag NO. 30 and the set value are repeatedly described. In FIG. 6(C), the “heartbeat” HB includes a transaction number 37, a timestamp 36, a type, a source 31, and a unicast address. In the type, the “heartbeat” is described.

In FIG. 6(D), the reply R includes a transaction number 37, a timestamp 36, a type, a source 31, a unicast address, a source at the requester, a transaction number at the requester, the number of items, a Tag NO. 30, a Tag description 32, an engineering unit 33, a current value 34, and a quality 35. In the type, the reply is described, and a set consisting of the Tag NO. 30 to the quality 35 are repeatedly described. In FIG. 6(E), the exception E includes a transaction number 37, a timestamp 36, a type, a source 31, a unicast address, the number of items, a Tag NO. 30, a cur-rent value 34, and a quality-35. In the type, the exception is described, and a set consisting of the Tag NO. 30 to the quality 35 are repeatedly described.

As described above, the multicast query MQ and the unicast query UQ are different in protocol, but include the same content. A reply R in response to a query MQ or UQ includes all information required to generate a duplicate of the Tag database 20, but an exception E is restricted to dynamic information only.

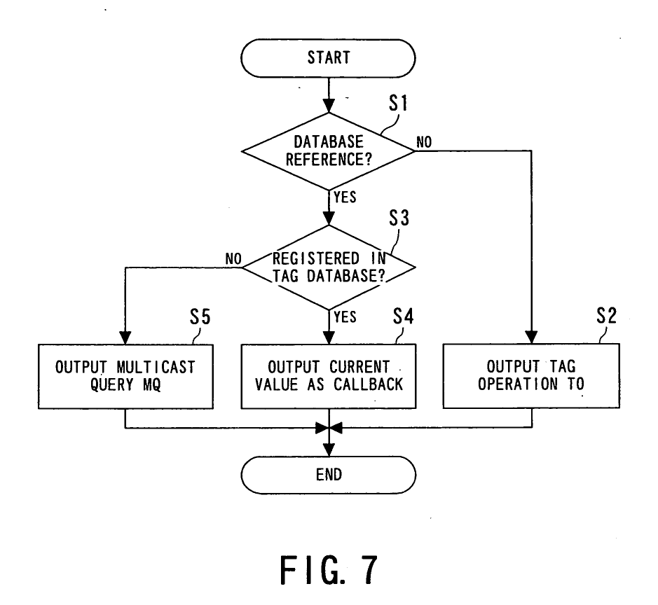

FIG. 7 is a flowchart showing the processing of a database reference DB by the Tag database input/output means 14 from the display means 16 and the gateway means 17 in the centralized plant monitoring and controlling apparatus according to the first embodiment of the present invention shown in FIG. 2. First, a determination is made as to whether or not a reference is made to a database (S1). If a reference is not made to the database, a Tag operation TO is output (S2). On the other hand, when a reference is made to the database, another determination is made as to whether or not the Tag has been registered in the Tag database 20. If the Tag has been registered, the current value is output as a callback (S4). If the Tag has not yet been registered, a multicast query MQ is output (S5).

Here, some database references DB are output by the display means 16 as local references, and other database references DB are output by the gateway means 17 to relay a multicast query MQ. The source is set to, for example, 0 for the former case and to a value other than 0 for the latter case. This enables a determination to be made as to whether or not a reply R results from a local reference. A reply R and an exception E in response to the database reference DB by the display means 16 are reported in an asynchronous manner as a callback CB, and the display means 16 updates the interactive screen of the display device 5 based on the current value of the reported Tag. A reply R and an exception E in response to the database reference DB by the gateway means 17 are output again to the information network 7, and finally are reported as a callback CB to the display means 16 in the centralized interactive unit 4.

The transaction number 37 included in a reply R and an exception E output by the control unit 2 or the individual interactive unit 3 that simulates the control unit 2 is a serial number with which the source 31 is updated independently, and thus whether or not a loss has occurred is detected by saving the transaction number 37 included in the previously received content in the source database 23 for comparison.

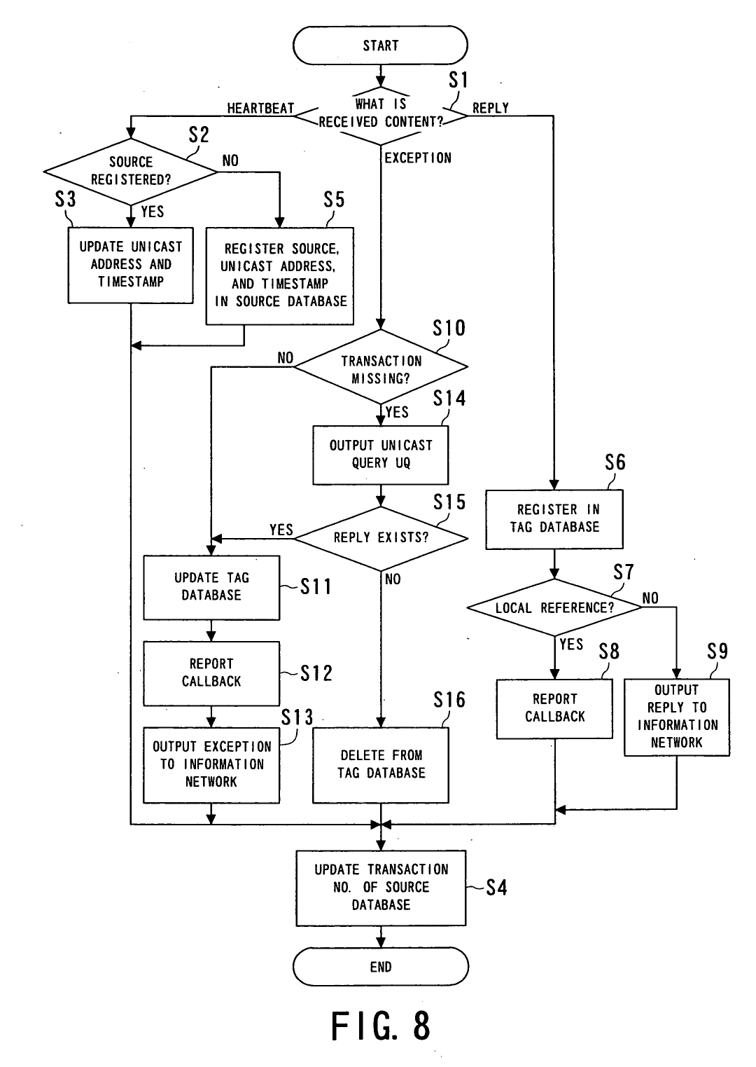

FIG. 8 is a flowchart showing the processing of a “heartbeat” HB, a reply R, and an exception E by the Tag database input/output means 14 from the transmission means 13. First, a determination is made as to whether the received content is a “heartbeat” HB, a reply R, or an exception E (S1). If the received content is a “heartbeat” HB, a determination is made as to whether or not the source has been registered (S2). If the source has been registered, the unicast address and the timestamp are updated (S3), and the transaction number of the source database is updated (S4). If a determination is made in step S2 that the source has not been registered, the source, the unicast address, and the timestamp are registered in the source database 23 (S5), and the transaction number of the source database is updated (S4).

Next, if a determination is made in step S1 that the received content is a reply R, it is registered in the Tag database 20 (S6), and another determination is made as to whether or not a local reference has been made (S7). If a local reference has been made, a callback CB is reported (S8). If a local reference has not been made, the reply R is output to the information network 7 (S9). The transaction number of the source database is then updated (S4).

If a determination is made in step S1 that the received content is an exception E, another determination is made as to whether or not a transaction is missing (S10). If no transaction is missing, the Tag database is updated (S11), and a callback CB is reported (S12). The exception E is then output to the information network 7 (S13), and the transaction number of the source database is updated (S4).

If a determination is made in step S10 that a transaction is missing, a unicast query UQ is output (S14), and a determination is made as to whether or not there is a reply R (S15). If there is a reply R, the flow proceeds to step S11. If there is no reply R, the Tag is deleted from the Tag database (S16) and the transaction number of the source database is updated (S4).

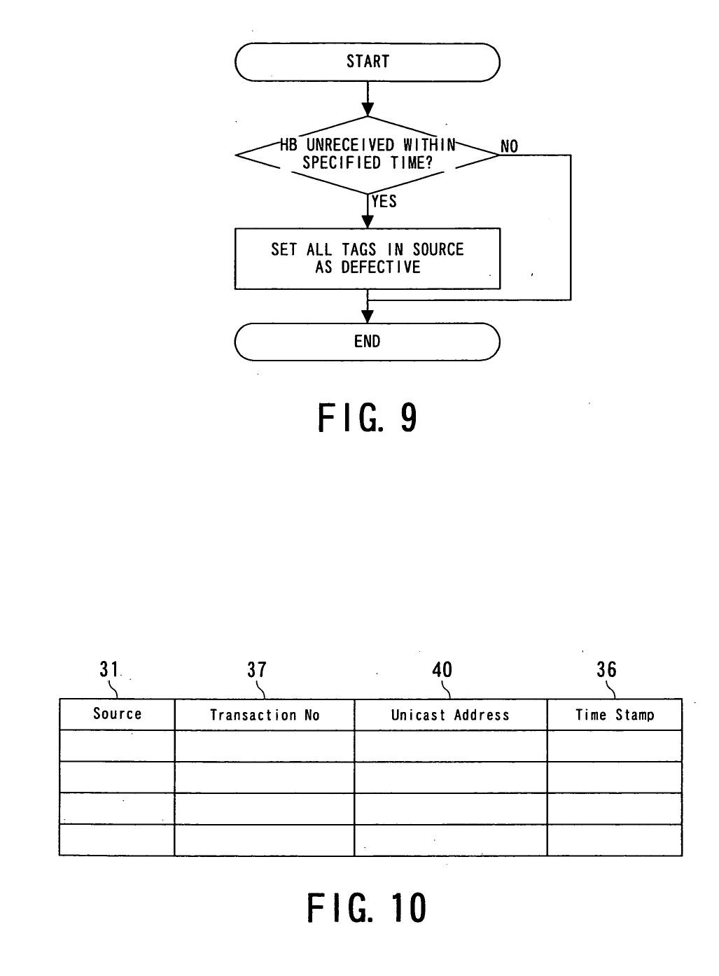

FIG. 9 is a flowchart showing the processing by the garbage collection means 15 in the centralized plant monitoring and controlling apparatus according to the first embodiment of the present invention shown in FIG. 2. A determination is made as to whether or not a “heartbeat” HB is received from the control unit 2 within a specified period of time (S1). If no “heartbeat” HB is received, all Tags of the relevant source are set as defective (S2).

FIG. 10 is a schematic block diagram of the source database 23 for storing the reception status of a “heartbeat” HB from each control unit 2. More specifically, the source database 23 includes a source 31, a transaction number 37, a unicast address 40, and a timestamp 36. This source database 23 is generated and updated by the Tag database input/output means 14. The garbage collection means 15 detects the loss of a function of the control unit 2 or the individual interactive unit 3 that simulates the control unit 2, serving as a source, according to the elapsed time from the latest updated date and time.

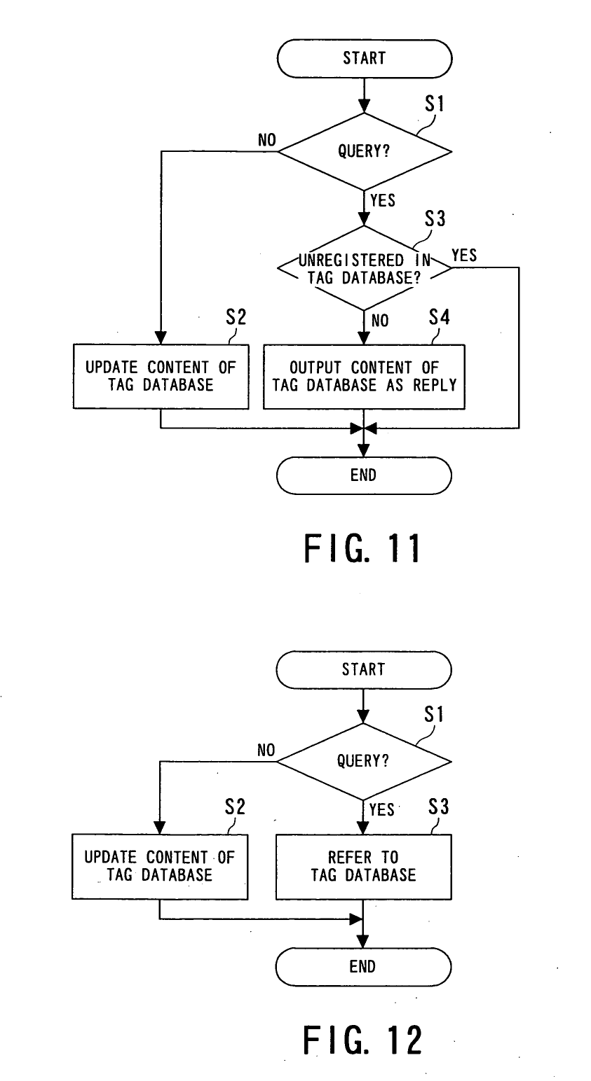

FIG. 11 is a flowchart showing the processing by the transfer means 12 in the control unit 2. First, a determination is made as to whether or not the received content is a query (S1). If it is not a query, the content of the Tag database is updated (S2). If it is a query, a determination is made as to whether or not the Tag is registered in the Tag database (S3), and the content of the Tag database is output as a reply (S4). FIG. 12 is a flowchart showing the processing by the gateway means 17 in the individual interactive unit 3. First, a determination is made as to whether or not the received content is a query (S1). If it is not a query, the content of the Tag database is updated (S2). If it is a query, a reference is made to the Tag database (S3).

As described above, the transfer means 12 does not output a reply R in response to a multicast query MQ for a nonexistent Tag. The gateway means 17 merely outputs a database reference DB to the Tag database input/output means 14.

As described above, according to the first embodiment, the centralized interactive unit connected to the information network regards the individual interactive unit as a control unit, and the Tag database in the interactive display unit is constructed based on plant state quantities of the control unit that has responded to a query. This enables the centralized interactive unit and individual interactive unit to be easily added and deleted. Furthermore, the specifications of the centralized interactive unit for centralized monitoring and controlling of operations can be made the same as those of the individual interactive unit at each plant. This eliminates the need for learning the operating procedures for individual devices, thus enabling the operation of a plurality of plants to be easily monitored in a centralized manner.

### Second Embodiment

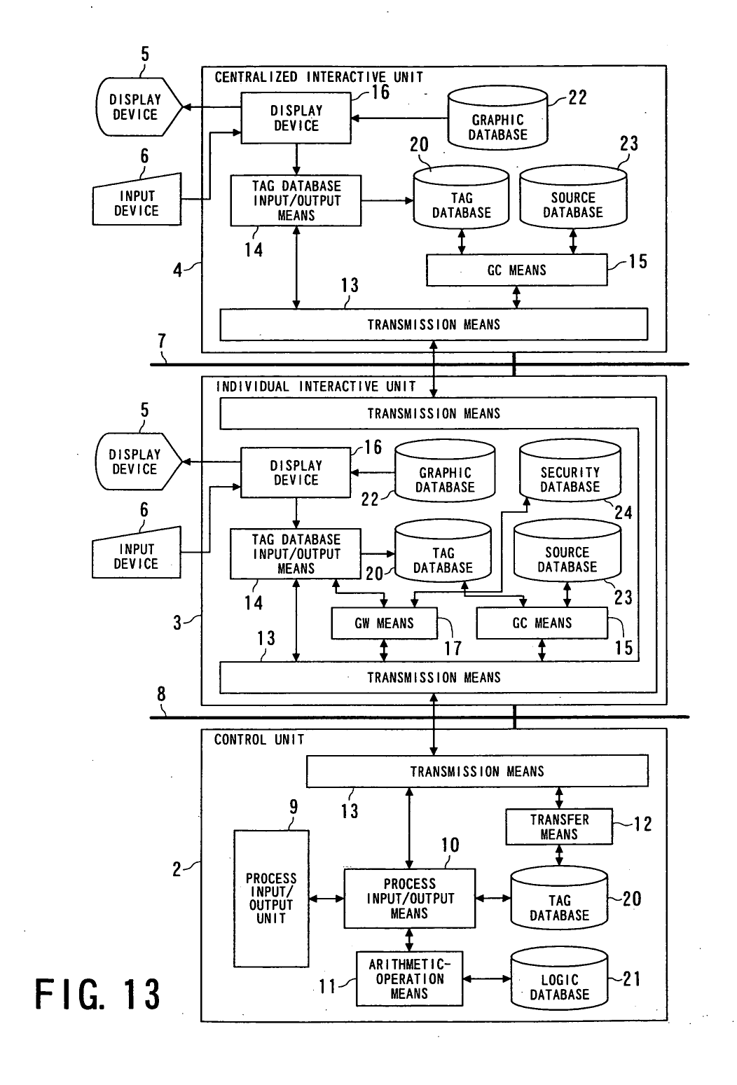

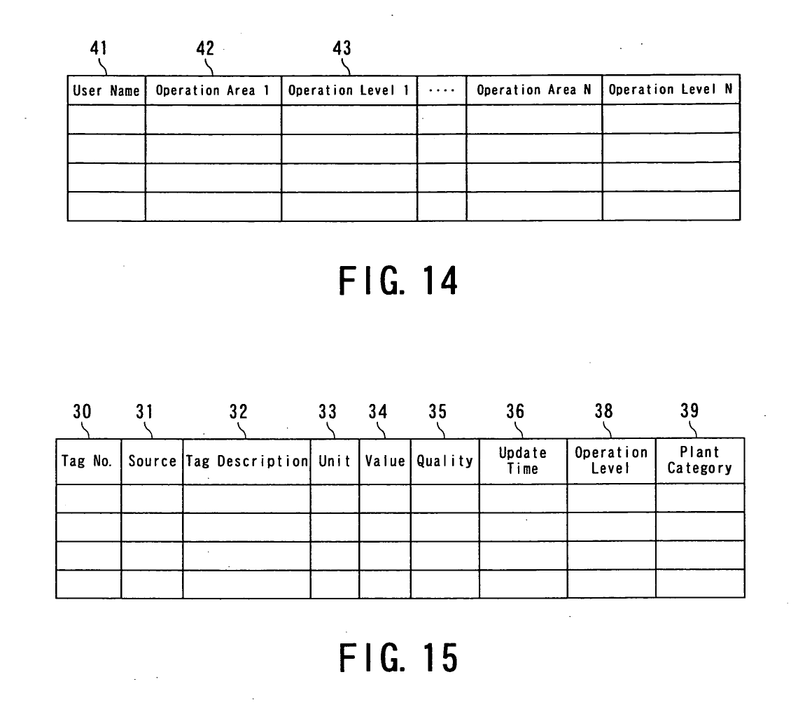

FIG. 13 is a detailed block diagram of a centralized plant monitoring and controlling apparatus according to a second embodiment of the present invention. In this second embodiment, compared with the first embodiment shown in FIG. 2, the individual interactive unit 3 includes a security database 24 for storing information about the restriction of a monitorable and operable range for each operator, and the gateway means 17 restricts the simulation range of the control unit 2 based on the definition in the security database 24. The same components as those shown in FIG. 2 are denoted with the same reference numerals, and will not be described.

The gateway means 17 of the individual interactive unit 3 restricts the simulation range of the control unit 2 based on the definition data in the security database 24 and the Tag information in the Tag database input/output means 14, and carries out data transmission to the centralized interactive unit 4 by the transmission means 13 via the information network 7.

FIG. 14 is a schematic block diagram of the security database 24. In the security database 24, at least a user name 41 of the operator, an operation area (operating plant device) 42, and an operation level 43 corresponding to the operation area are registered, and the gateway means 17 inputs the user name of the operator acquired from the centralized interactive unit 4, and outputs the definition data to the gateway means 17. As shown in FIG. 14, a plurality of operation areas and operation levels can be registered for the user in the security database 24.

FIG. 15 is a schematic block diagram of the Tag database 20 according to the second embodiment. In the Tag database 20 according to the second embodiment, at least an operation level 38 and a plant category (plant device category) 39 are stored. The gateway means 17 restricts the simulation range of the control unit 2 only to the Tag information required for the operator based on the definition data in the security database 24 and the registration information in the Tag database 20.

According to this second embodiment, the gateway means 17 can restrict the monitorable and operable range for each operator by restricting the simulation range of the control unit 2 based on the definition in the security database 24. As a result, a monitoring and operating function according to the operator level can be provided, and hence the number of incorrect operations by the operator can be reduced. Furthermore, only the information required by the operator is transmitted, and hence the load on the information network and control network can be lessened.

### Third Embodiment

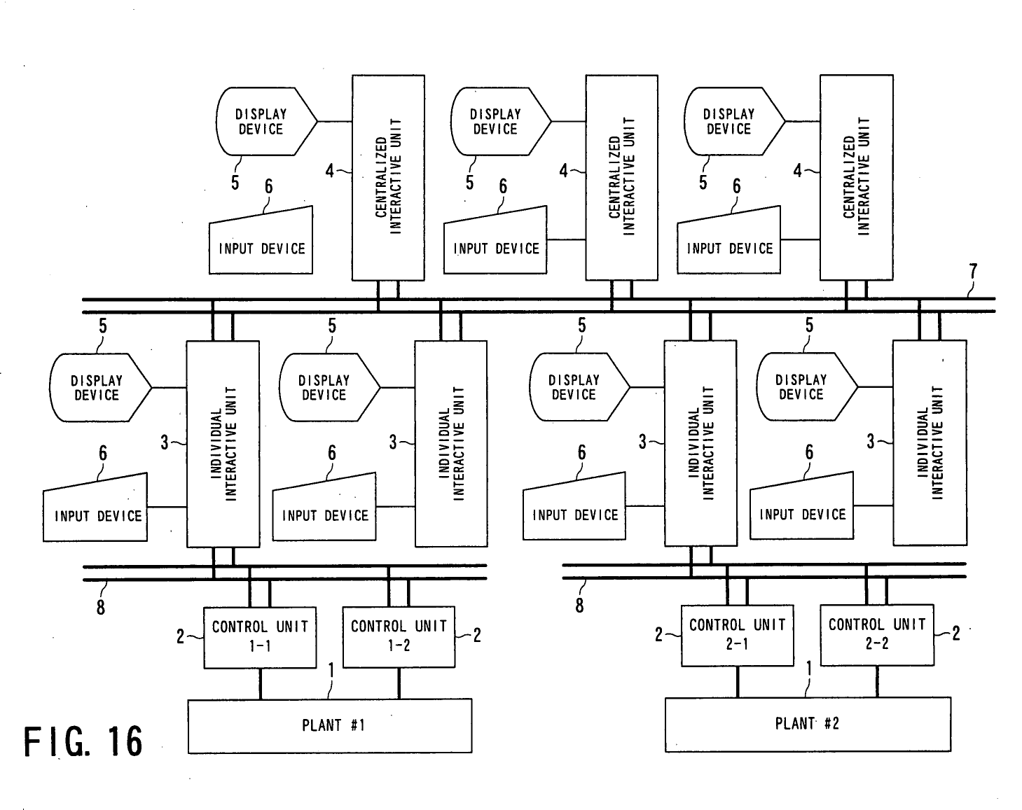

FIG. 16 is a block diagram of a centralized plant monitoring and controlling apparatus according to a third embodiment of the present invention. In this third embodiment, compared with the first embodiment shown in FIG. 1, the information network 7, the control network 8, the control unit 2, the centralized interactive unit 4, and the individual interactive unit 3 are redundantized, and the control units 2, the centralized interactive units 4, and the individual interactive units 3 carry out multicast transmission to all redundantized information networks 7 and control networks 8 and receive data one transaction at a time on a first-come-first-served basis. The same components as those shown in FIG. 1 are denoted with the same reference numerals, and will not be described.

Plant state quantities, such as temperature, pressure, flow rate, and valve open/close status, collected from the plant 1 are input to the redundantized control units 2 and subjected to control and arithmetic operations. The result of arithmetic operations is output as the amount of control, whereas the plant state quantities are output to the redundantized control networks 8 as Tags. The plant state quantities output to the control networks 8 are input to the individual interactive units 3.

Furthermore, the redundantized individual interactive units 3 having connections to the redundantized information networks 7 transfer state quantities output to the control networks 8 to the information networks 7. The centralized interactive unit 4 inputs the state quantities output to the control network 8 or the information network 7, and displays and updates the interactive screen of the display device 5, including the plant state quantities, selected and requested by the operator using the input device 6.

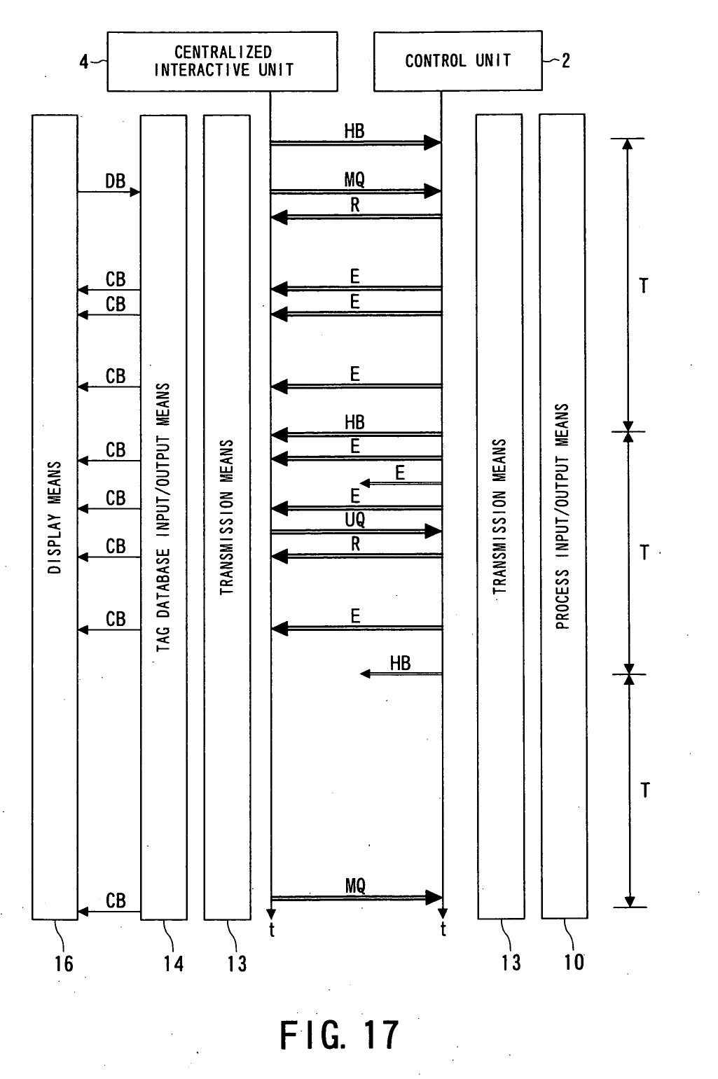

FIG. 17 is an illustration of a transmission scheme employed by the plant centralized monitoring and controlling apparatus according to the third embodiment shown in FIG. 16. Since the networks are redundantized, data is output to all networks, and the receiver selects only the transaction arriving first and ignores the subsequent arriving transactions.

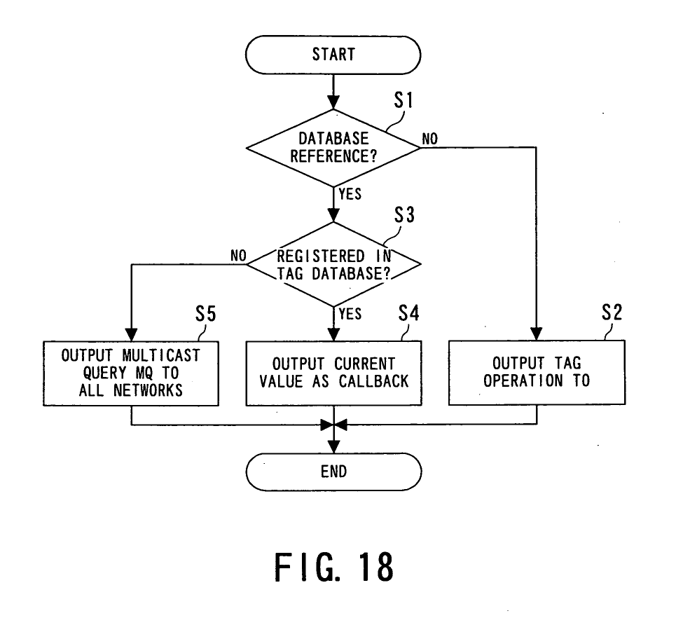

FIG. 18 is a flowchart showing the processing of a database reference DB by the Tag database input/output means 14 from the display means 16 and the gateway means 17 in the centralized plant monitoring and controlling apparatus according to the third embodiment. First, a determination is made as to whether or not a reference is made to a database (S1). If a reference is not made to a database, a Tag operation TO is output (S2). On the other hand, when a reference is made to a database, another determination is made as to whether or not the Tag has been registered in the Tag database 20. If the Tag has been registered, the current value is output as a callback (S4). If the Tag has not yet been registered, a multicast query MQ is output to all networks (S5).

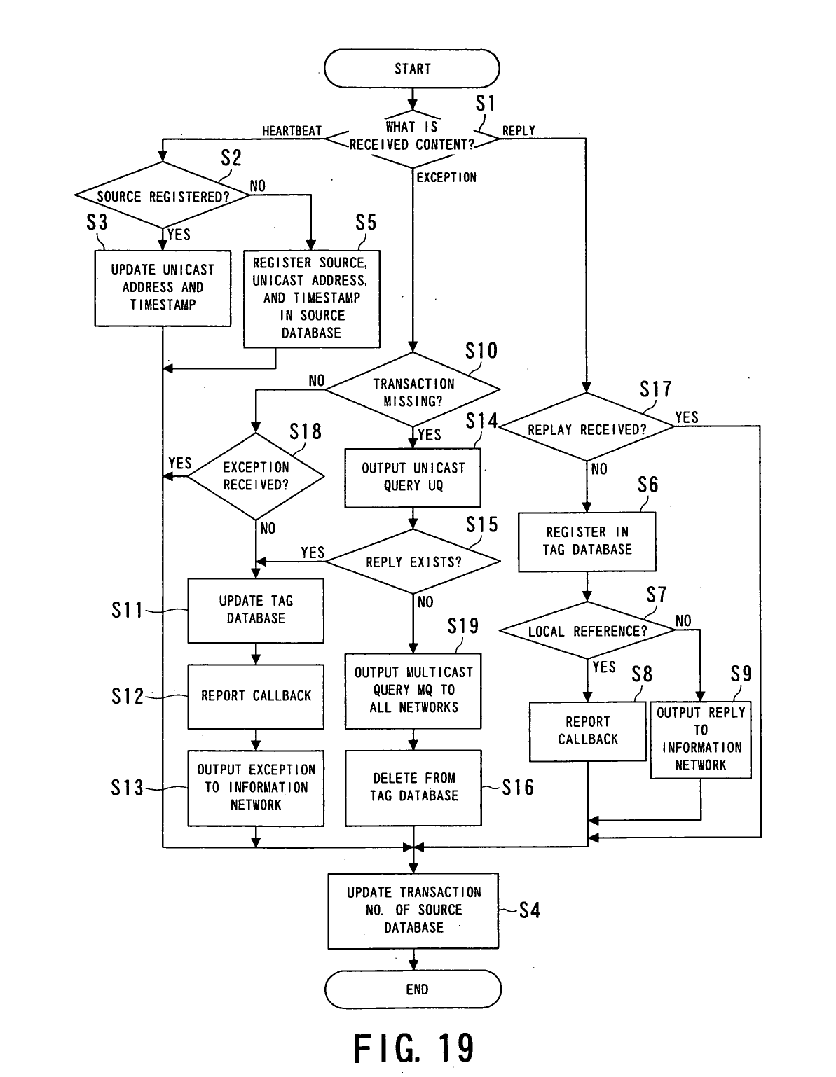

FIG. 19 is a flowchart showing the processing of a “heartbeat” HB, a reply R, and an exception E by the Tag database input/output means 14 from the transmission means 13. Compared with the flowchart shown in FIG. 8, step S17, step S18, and step S19 are additionally provided.

With this transmission scheme, the centralized interactive unit 4 does not need to know whatever multiplicity is employed by the control unit 2 or the individual interactive unit 3. Furthermore, a loss of function in a multiplexed apparatus can be detected by confirming that there is no reply R to a multicast query MQ.

According to this third embodiment, addition and modification of component devices, including a change in the degree of redundancy, can be carried out without interrupting the operations, let alone server switching during operation. This enhances the plant availability. Furthermore, since the Tag database 20 exists only in the control unit 2 immediately after startup, it is not necessary to take into account, for example, matching to the Tag database existing in the interactive display unit. This improves the maintainability.

### Fourth Embodiment

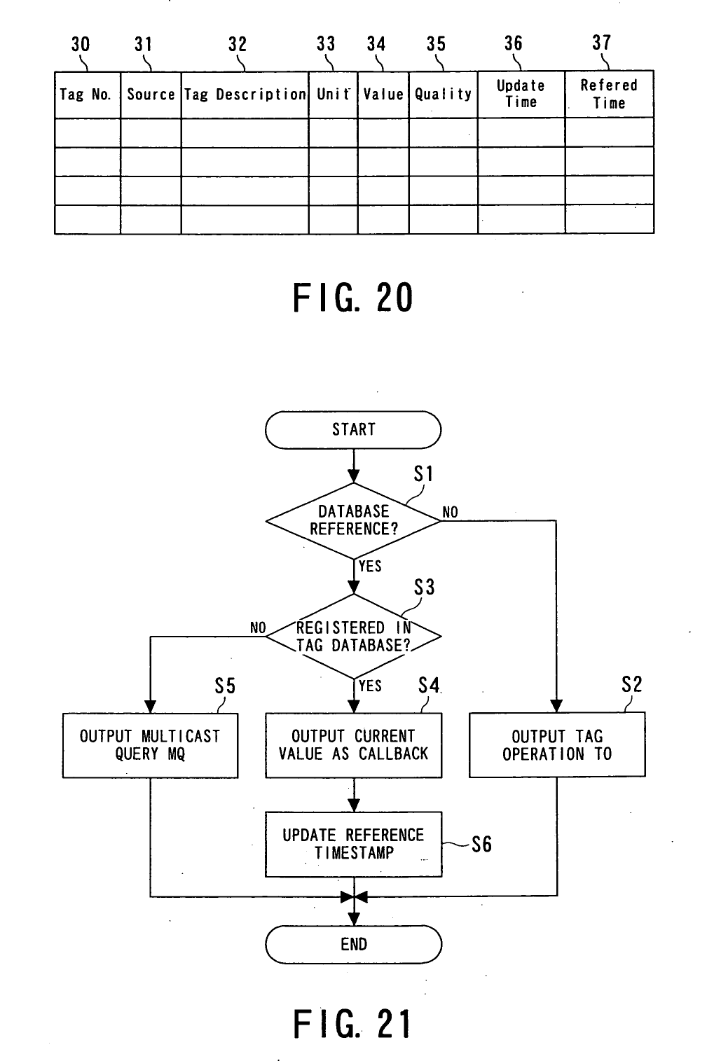

FIG. 20 is a schematic block diagram of the Tag database 20 in a centralized plant monitoring and controlling apparatus according to a fourth embodiment of the present invention. Compared with the Tag database 20 according to the first embodiment shown in FIG. 4, a reference timestamp 37 for retaining the latest date and time when a database reference DB occurred for each Tag is additionally provided.

FIG. 21 is a flowchart showing the processing of a database reference DB by the Tag database input/output means 14 from the display means 16 and the gateway means 17 in the centralized plant monitoring and controlling apparatus according to the fourth embodiment. Compared with the Tag database input/output means 14 according to the first embodiment shown in FIG. 7, step S6 is additionally provided. First, a determination is made as to whether or not a reference is made to a database (S1). If a reference is not made to a database, a Tag operation TO is output (S2). On the other hand, when a reference is made to a database, another determination is made as to whether or not the Tag has been registered in the Tag database 20. If the Tag has been registered, the current value is output as a callback (S4). The reference timestamp is then updated (S6). If a determination is made in step S3 that the Tag has not been registered, a multicast query MQ is output (S5). As described above, in step S6 the Tag database input/output means 14 updates the reference date and time in the Tag database 20 in response to each database reference DB.

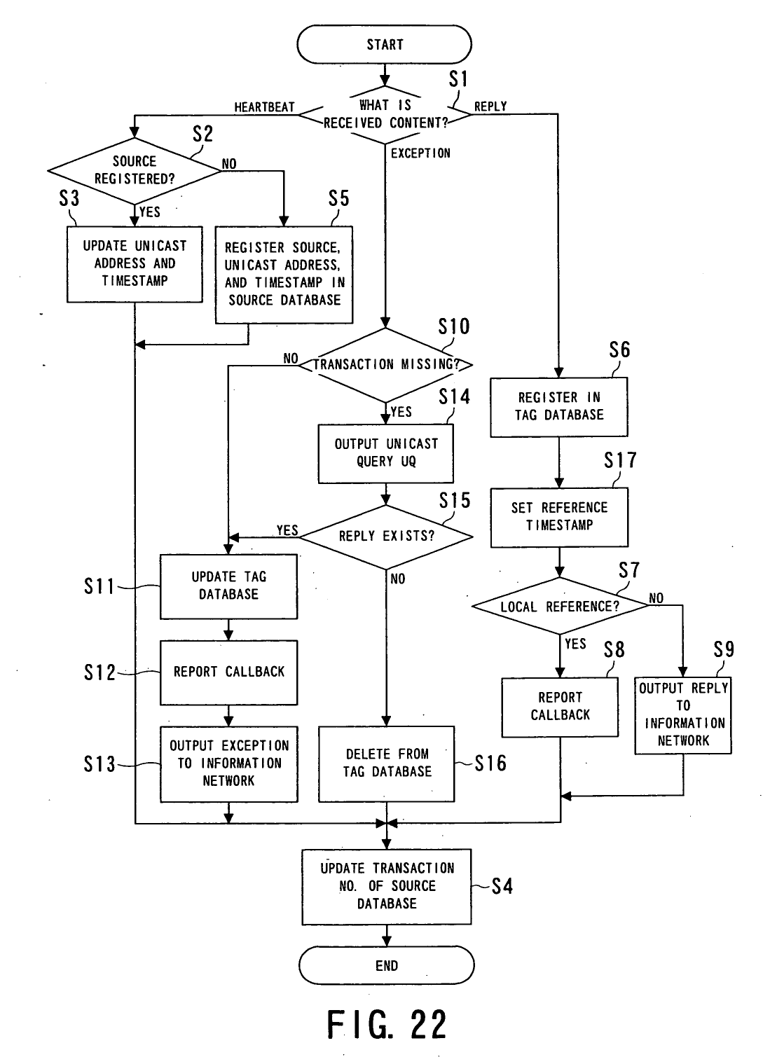

FIG. 22 is a flowchart showing the processing of a “heartbeat” HB, a reply R, and an exception E by the transmission means 13 in the centralized plant monitoring and controlling apparatus according to the fourth embodiment. Compared with the processing according to the first embodiment shown in FIG. 8, step S17 in which a reference timestamp is set is additionally provided.

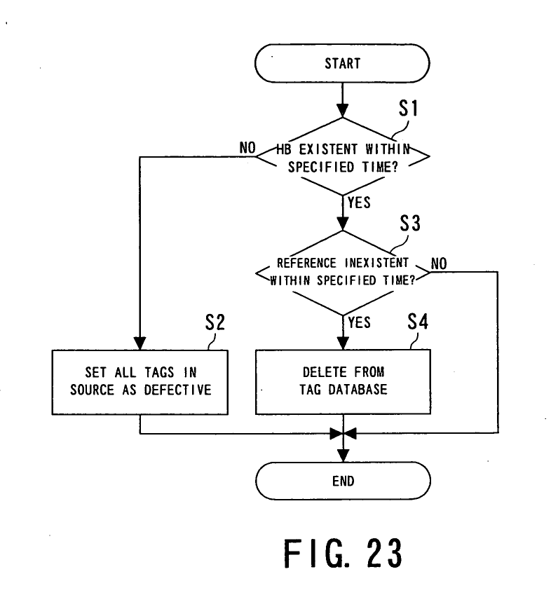

FIG. 23 is a flowchart showing processing by the garbage collection means 15 in the centralized plant monitoring and controlling apparatus according to the fourth embodiment. First, a determination is made as to whether or not a “heartbeat” HB is received from the control unit 2 within a specified period of time (S1). If no “heartbeat” HB is received, all Tags in the relevant source are set as defective (S2). On the other hand, when a “heartbeat” HB is received within a specified period of time, a determination is made as to whether or not a reference is made within a specified period of time (S3). If there is no reference made, the Tag is deleted from the Tag database (S4). As described above, by the processing in step S3 and step S4, the garbage collection means 15 detects there is no database reference DB based on the elapsed time from the reference data and time in the Tag database 20 and deletes Tags existing for more than a certain period of time.

According to this fourth embodiment, Tags not needed by clients and Tags referred to less frequently can be ruled out of a query resulting from missing notification of a change in state quantity output by the process input/output means 10. This lessens the load on the information network 7 and the control network 8. Therefore, an interactive display unit with high responsiveness can be accomplished.

### Fifth Embodiment

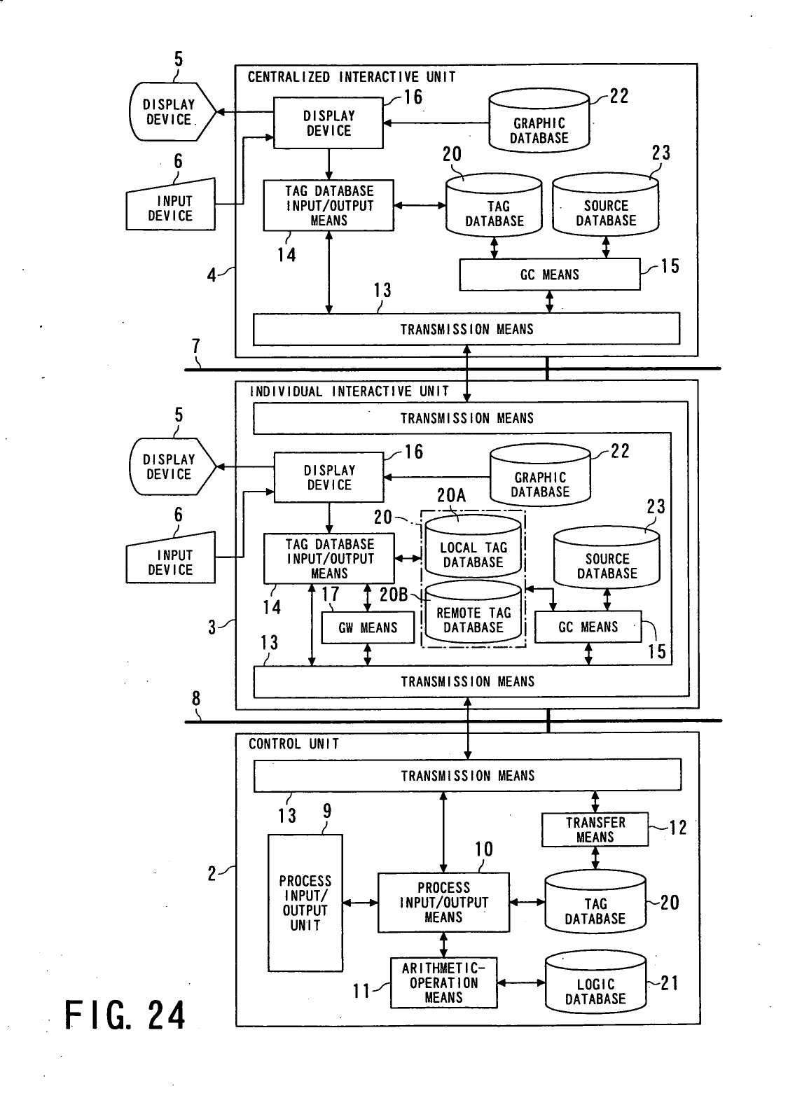

FIG. 24 is a detailed block diagram of a centralized plant monitoring and controlling apparatus according to a fifth embodiment of the present invention. In this fifth embodiment, compared with the first embodiment shown in FIG. 2, the Tag database 20 of the individual interactive unit 3 includes a local Tag database 20A for storing Tags requested by the Tag database 20 itself and a remote Tag database 20B for storing Tags requested by the gateway means 17. The same components as those shown in FIG. 2 are denoted with the same reference numerals, and will not be described.

As shown in FIG. 24, the Tag database 20 is classified into the local Tag database 20A for local references requested by its own display means 16 and the remote Tag database 20B for remote references requested by the gateway means 17 via the information network 7.

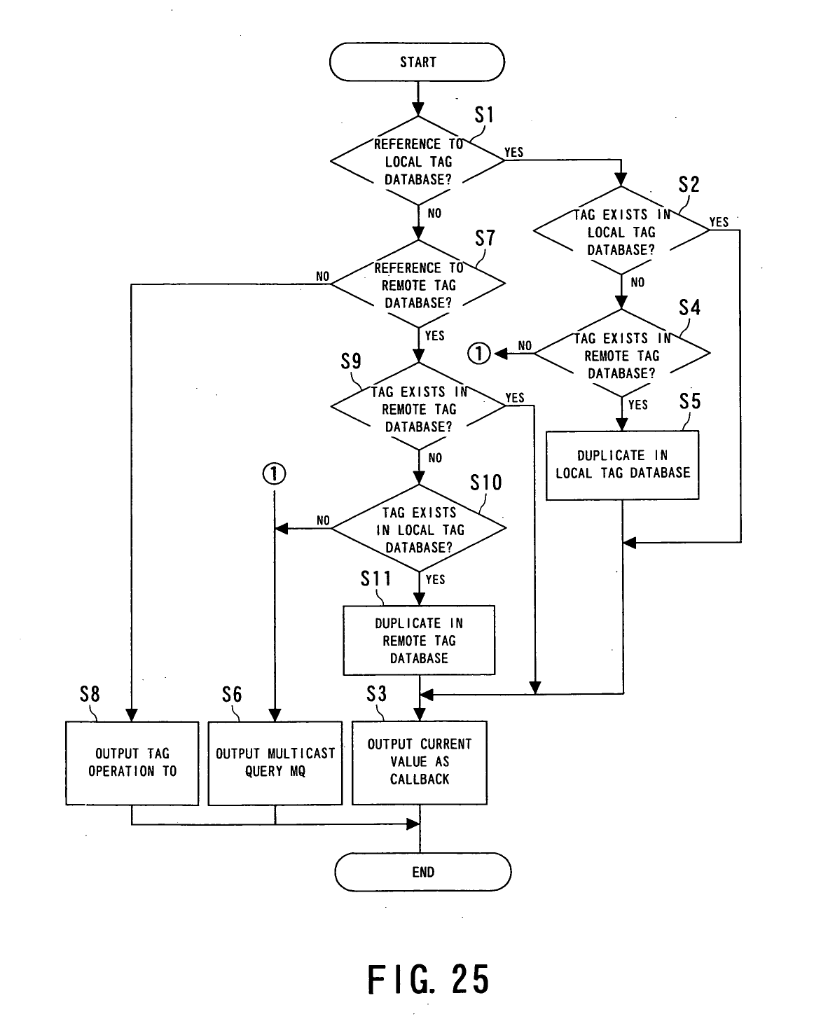

FIG. 25 is a flowchart showing the processing of a database reference DB by the Tag database input/output means 14 from the display means 16 and the gateway means 17 according to the fifth embodiment of the present invention. First, a determination is made as to whether or not a reference is made to the local Tag database (S1). If a reference is made to the local Tag database, another determination is made as to whether or not the reference Tag exists in the local Tag database (S2). If the reference Tag exists in the local database, the current value is called back (S3).

On the other hand, if a determination is made in step S2 that the reference Tag does not exist in the local Tag database, another determination is made as to whether or not the remote Tag database exists (S4). If the reference Tag exists in the remote Tag database, it is duplicated in the local Tag database (S4) and the current value is called back (S3). If a determination is made in step S5 that the reference Tag does not exist in the remote Tag database, a multicast query MQ is output (S6).

If a determination is made in step S1 that a reference is not made to the local Tag database, another determination is made as to whether or not a reference is made to the remote Tag database (S7). If a reference is not made to the remote database, a Tag operation TO is output (S8). In short, if a reference is made neither to the local database nor to the remote database, a Tag operation TO is output.

Next, if a reference is made not to the local Tag database but to the remote database, a determination is made as to whether or not the reference Tag exists in the remote Tag database (S9). If the reference Tag exists in the remote Tag database, the current value is output as a callback (S3). On the other hand, if the reference Tag does not exist in the remote Tag database, a determination is made as to whether or not the reference Tag exists in the local Tag database (S10). If the reference Tag does not exist in the local Tag database, a multicast query MQ is output (S6). If the reference Tag exists in the local Tag database, it is duplicated in the remote Tag database (S11), and the current value is called back (S3).

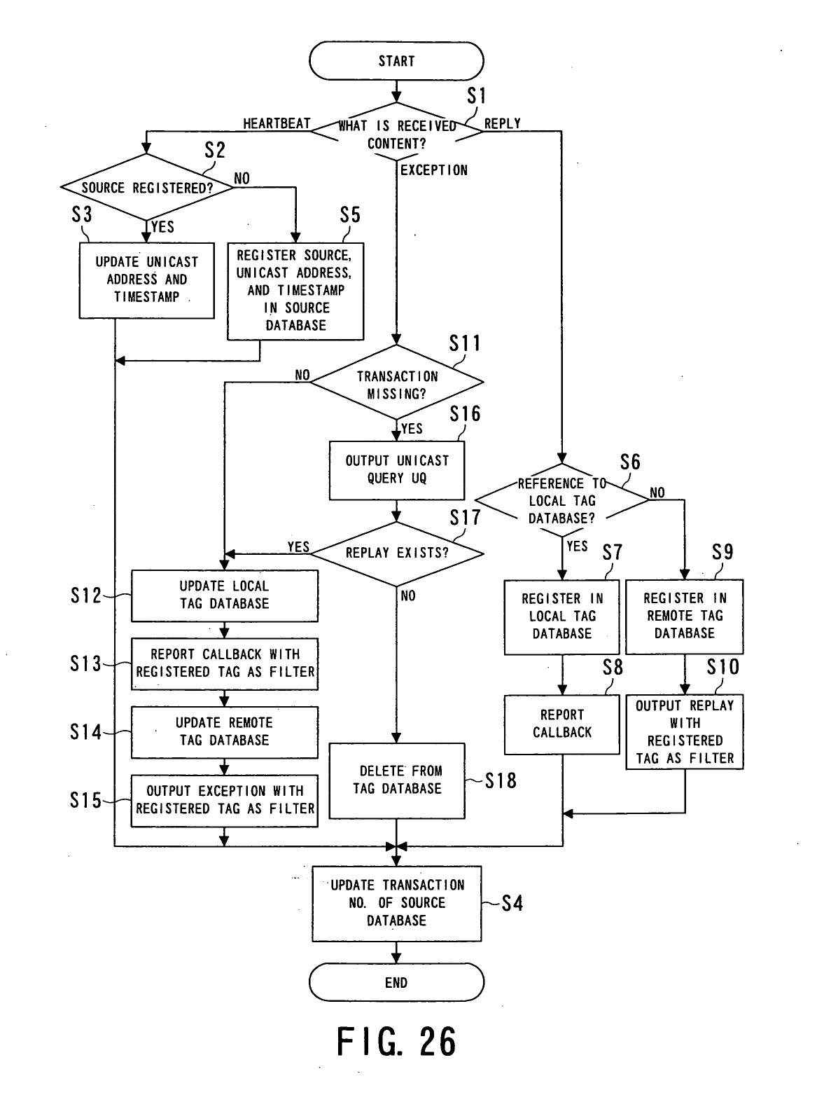

FIG. 26 is a flowchart showing the processing of a “heartbeat” HB, a reply R, and an exception E by the transmission means 13 according to the fifth embodiment of the present invention. First, a determination is made as to whether the received content is a “heartbeat” HB, a reply R, or an exception E (S1). If the received content is a “heartbeat” HB, a determination is made as to whether or not the source has been registered (S2). If the source has been registered, the unicast address and the timestamp are updated (S3), and the transaction number of the source database is updated (S4). If a determination is made in step S2 that the source has not been registered, the source, the unicast address, and the timestamp are registered in the source database 23 (S5), and the transaction number of the source database is updated (S4).

Next, if a determination is made in step S1 that the received content is a reply R, another determination is made as to whether or not a reference is made to the local Tag database (S6). If a reference is made to the local Tag database, the Tag is registered in the local Tag database (S7). A callback is then reported (S8), and the transaction number of the source database is updated (S4). If a determination is made in step S6 that a reference is not made to the local Tag data, the Tag is registered in the remote Tag database (S9). A reply is then output with the registered Tag as a filter (S10), and the transaction number of the source database is updated (S4).

If a determination is made in step S1 that the received content is an exception E, another determination is made as to whether or not a transaction is missing (S11). If no transaction is missing, the local Tag database is updated (S12), a reply is output with the registered Tag as a filter (S13), and the remote Tag database is updated (S14). An exception is then output with the registered Tag as a filter (S15), and the transaction number of the source database is updated (S4).

If a determination is made in step S11 that a transaction is missing, a unicast query UQ is output (S16), and a determination is made as to whether or not there is a reply R (S17). If there is a reply R, the flow proceeds to step S12. If there is no reply R, the Tag is deleted from the Tag database (S18), and the transaction number of the source database is updated (S4).

As described above, a database reference DB made by the display means 16 is registered in the local Tag database 20A of the Tag database 20, separated from a database reference DB made by the gateway means 17. In response to a reply R and an exception E from the control unit 2, a callback CB and a second output to the information network 7 are performed using the Tags registered in each database as filters.

According to this fifth embodiment, a change in state quantity from the control unit 2 is not reported as a callback which includes what is not required by the client, and furthermore, the load on the information network 7 can be lessened. Therefore, an interactive display unit which exhibits high responsiveness can be obtained. Furthermore, the load on the clients and the networks can be reduced by making the Tag database 20 independent for each client.

### Sixth Embodiment

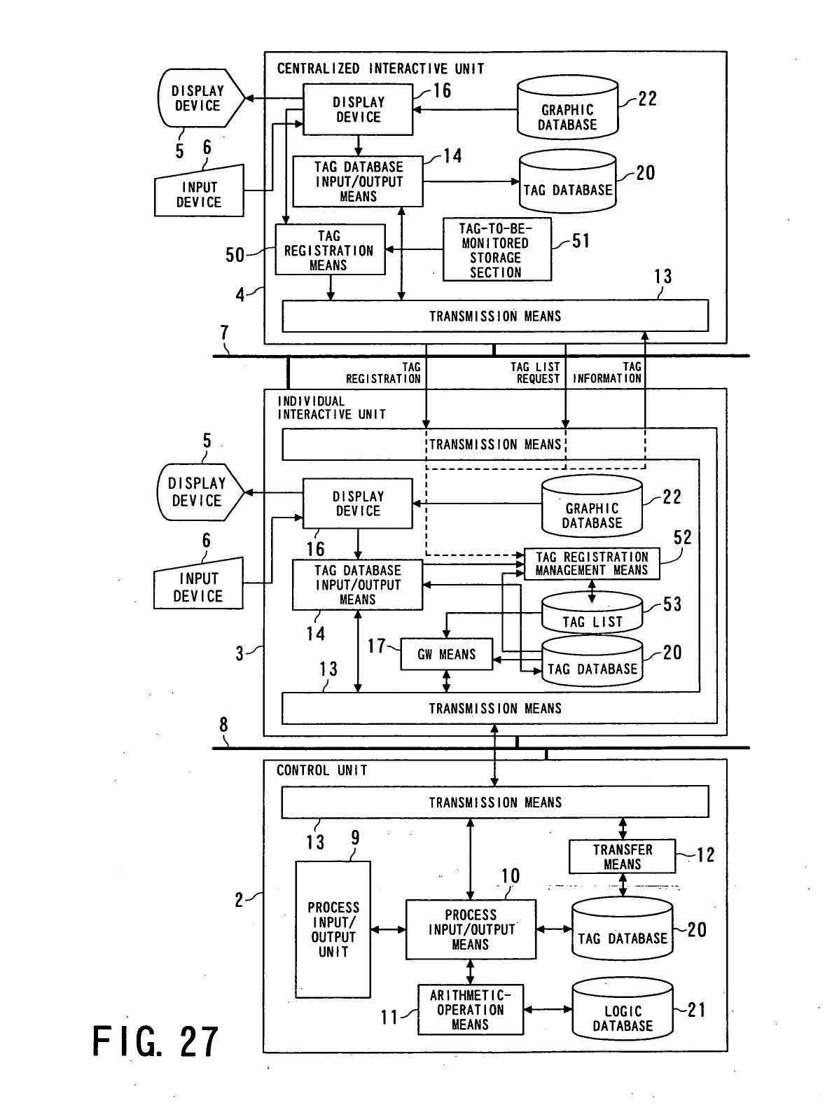

FIG. 27 is a detailed block diagram of a centralized plant monitoring and controlling apparatus according to a sixth embodiment of the present invention. In this sixth embodiment, compared with the first embodiment shown in FIG. 2, the centralized interactive unit 4 in the centralized operation monitoring and controlling apparatus additionally includes Tag registration means 50 for registering a Tag to be monitored in the centralized interactive unit 4 and a Tag-to-be-monitored storage section 51 where a Tag to be monitored is set, and furthermore, the individual interactive unit 3 additionally includes Tag registration management means 52 for managing Tags whose registration is requested and a Tag list 53 for storing Tag information about registered Tags.

The centralized interactive unit 4 outputs a registration request specifying a Tag required for monitoring to the individual interactive unit 3, which then stores the Tag whose registration is requested by the centralized interactive unit 4 in the Tag list 53. Furthermore, the individual interactive unit 3 converts and transmits the state quantity of the Tag stored in the Tag list 53 in accordance with the format at the centralized interactive unit 4 by the gateway means 17.

As a result, a transmission structure for Tag information registered by the centralized interactive unit 4 can be realized. More specifically, a Tag to be monitored is registered in the individual interactive unit 3 and the control unit 2 from the centralized interactive unit 4, and the registered Tag state quantity is converted and transmitted by the individual interactive unit 3 in accordance with the information format at the centralized interactive unit 4. This achieves easy connection and flexible addition and deletion of Tags in response to a change in the operational utilization.

In FIG. 27, Tags to be monitored according to the operational state (e.g., normal operation, start/stop, and out of operation) are pre-stored in the Tag-to-be-monitored storage section 51, so that, for example, the area for the monitoring system is made different between the individual interactive unit 3 and the centralized interactive unit 4. The centralized interactive unit 4 constituting the centralized monitoring and controlling apparatus monitors Tags specified by the input device 6 or Tags set in the Tag-to-be-monitored storage section 51.

The Tag registration means 50 inputs a Tag to be monitored from the input device 6 or the Tag-to-be-monitored storage section 51, and makes a request for Tag registration to the relevant individual interactive unit 3 via the transmission means 13. The request is input to the Tag registration management means 52 of the relevant individual interactive unit 3. The Tag registration management means 52 acquires Tag information for the Tag whose registration is requested from the Tag database 20 and saves it in the Tag list 53.

The Tag information in this case includes not only variable information, such as the Tag status value, but also fixed information, such as the Tag name. If there is no registration request, the Tag registration management means 52 is started up by the Tag database input/output means 14 to update the Tag status value to the latest value. After the Tag status value has been updated, the gateway means 17 is started up. The gateway means 17 converts and edits the Tag status values saved in the Tag list 53 into a format in compliance with the centralized interactive unit 4 and then transfers the Tag status values to the centralized interactive unit 4. The transferred Tag status value is input to the Tag database input/output means 14 of the centralized interactive unit 4, and is updated in the centralized Tag database 50.

According to this sixth embodiment, the status value of the Tag to be monitored in the relevant individual interactive unit 3 can be transferred by a specification from the centralized interactive unit 4. Thus, even if a change is made to the operational state at the centralized interactive unit 4, the Tag to be monitored can easily be switched, added, or deleted. Furthermore, the transmission load on the information network 7 can be restricted to the amount of information required for centralized operations.

### Seventh Embodiment

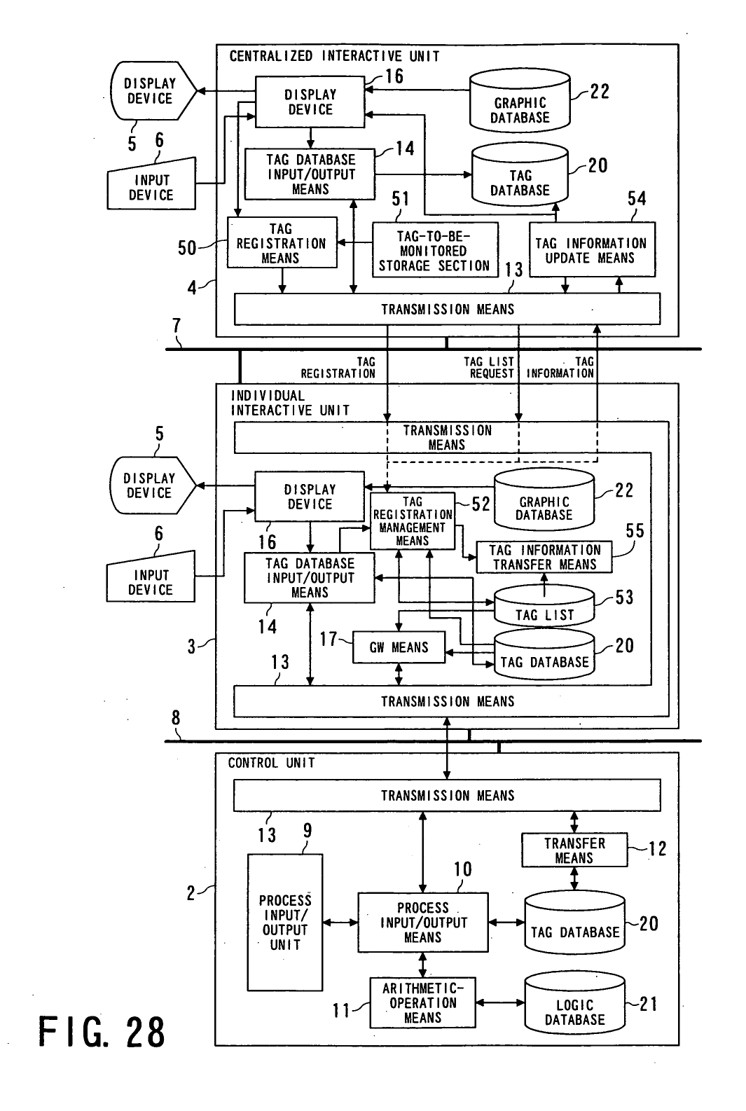

FIG. 28 is a detailed block diagram of a centralized plant monitoring and controlling apparatus according to a seventh embodiment of the present invention. In this seventh embodiment, compared with the sixth embodiment shown in FIG. 27, the centralized interactive unit 4 is additionally provided with Tag information update means 54 for updating Tag information about Tags to be centrally monitored, and the individual interactive unit 3 is additionally provided with Tag information transmission means 55 for converting and transferring the information about the Tag list subjected to Tag registration management in accordance with the format of the centralized interactive unit 4.

The centralized interactive unit 4 outputs a request for updating the Tag information of the control unit 2 to the individual interactive unit 3, and the individual interactive unit 3 adds a unique identification ID to the Tag information in the control unit 2, i.e., the Tag information whose updating is requested by the centralized interactive unit 4, and converts and transmits the Tag information in accordance with the format of the centralized interactive unit 4.

In FIG. 28, the centralized interactive unit 4 constituting the centralized monitoring and controlling apparatus starts up the Tag information update means 54 to construct Tag information to be monitored by each individual interactive unit 3 in the centralized Tag database 50. The Tag information update means 54 makes a request for updating the Tag information to the relevant individual interactive unit 3 via the transmission means 13. The Tag registration management means 52 of the relevant individual interactive unit 3 that has received a request for updating the Tag information starts up the Tag information transfer means 55. The Tag information transfer means 55 converts and edits the Tag information in the Tag list 53 into a structured format of the Tag information of the centralized interactive unit 4, which is the centralized monitoring and controlling apparatus, and transfers the Tag information to the centralized interactive unit 4. The term Tag information used in this description means a fixed information section such as the Tag name and the unit.

The transferred Tag information is input to the Tag information update means 54 of the centralized interactive unit 4, and is updated in the centralized Tag database 50. At this time, the Tag information update means 54 adds to the Tag NO. a unique ID assigned to each individual interactive unit 3 at the centralized interactive unit 4 and saves the Tag NO. so that any duplication of Tag NO. in each individual interactive unit 3 does not cause a problem in the centralized interactive unit 4 for performing centralized monitoring and controlling.

Furthermore, when new Tag information from the individual interactive unit 3 is to be updated, the Tag information update means 54 compares the current Tag information of the corresponding individual interactive unit 3 in the Tag data table 20 with the Tag information to be updated, displays which Tags are to be added or deleted on the display device 5 via the display means 16, and updates the Tag information only after confirmation by the operator is obtained. Because of this, updating of the Tag information can be carried out appropriately. It is noted that this confirmation can be omitted.

According to this seventh embodiment, at a request from the interactive display unit 4 for centralized monitoring and controlling, the Tag information of the Tag to be monitored in the relevant individual interactive unit 3 can be automatically constructed in the centralized interactive unit 4 for centralized monitoring and controlling. Furthermore, since any modifications to the Tag information at the individual interactive unit 3 can easily be reflected in the centralized Tag database at a request from the centralized interactive unit 4 for centralized monitoring and controlling, superior maintainability can be achieved.

### Eighth Embodiment

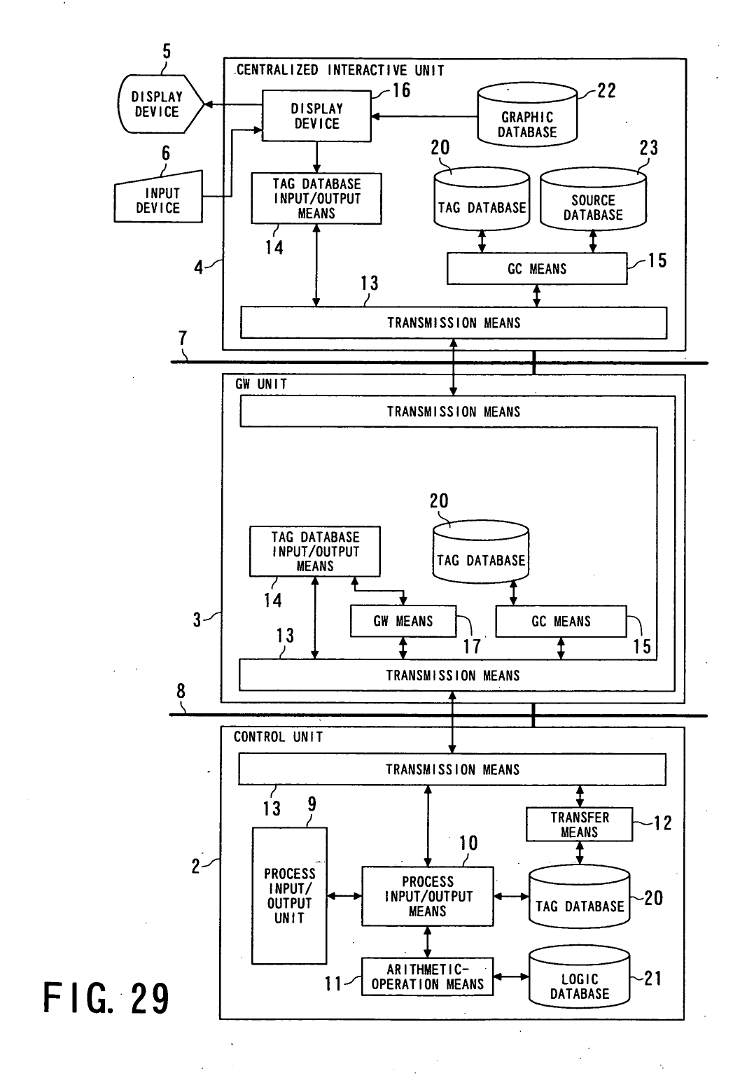

FIG. 29 is a detailed block diagram of a centralized plant monitoring and controlling apparatus according to an eighth embodiment of the present invention. In this eighth embodiment, compared with the first embodiment shown in FIG. 2, the individual interactive unit 3 lacks the display device 5 for interactive operation by the operator, the input device 6, the display device 16, and the graphic database 22.

According to this eighth embodiment, the cost and space associated with the installation of an individual interactive unit (GW unit) not required for interactive operation in normal centralized monitoring can be reduced.

### INDUSTRIAL APPLICABILITY

According to the centralized plant monitoring and controlling apparatus with the above-described structure of the present invention, multicast-based transmission is used when a plurality of plants are operated in a centralized manner using a plurality of interactive display units. Because of this, a centrally monitoring and controlling apparatus and method which exhibits sufficiently high responsiveness and flexibility to take an action in response to a change in the configuration can be achieved. Therefore, the present invention has a high industrial applicability to plant monitoring systems, which will become more and more diverse.

1. An apparatus for centrally monitoring and controlling plants, comprising:
a centralized interactive unit for monitoring and controlling the operation of a plurality of plants;
an individual interactive unit for monitoring and controlling a plant;
an information network for connecting the centralized interactive unit and the individual interactive unit;
a control unit for controlling a plant;
a control network for connecting the control unit and the individual interactive unit; and
gateway means which is disposed in the individual interactive unit and includes a transmission function equivalent to the control unit from the viewpoint of the individual interactive unit,
wherein the control unit includes means for inputting a state quantity of a plant as a Tag into a Tag database; means for multicasting a significant change in the state quantity of the plant to the control network or multicasting a “heartbeat” indicating the integrity thereof to the control network if there is no significant change in the state quantity of the plant; and means for returning the content of the Tag database in response to a query about the state quantity input from the control network and updating the content of the Tag database in response to an operation,
wherein the individual interactive unit includes means for displaying the state quantity of a Tag on an interactive screen of a plant if the Tag defined on the interactive screen exists in the Tag database of the individual interactive unit itself; means for multicasting a query about the state quantity to the control network if the Tag defined on the interactive screen does not exist in the Tag database of the individual interactive unit itself and for registering a response from the control unit in the Tag database for update; and means for setting a Tag included in the control unit as defective if a “heartbeat” indicating the integrity of the control unit is not received from the control unit for a particular period of time, and
wherein the centralized interactive unit includes means for displaying the state quantity of a Tag on an interactive screen of a plant if the Tag defined on the interactive screen exists in the Tag database of the centralized interactive unit itself; means for multicasting a query about the state quantity to the control network via the information network and the gateway means if the Tag defined on the interactive screen does not exist in the Tag database of the centralized interactive unit itself and for registering a response from the control unit in the Tag database for update; and means for setting a Tag included in the control unit as defective if a “heartbeat” indicating the integrity of the control unit is not received from the control unit for a particular period of time.

2. The apparatus for centrally monitoring and controlling plants according to claim 1, wherein the individual interactive unit includes a security database storing information for restricting a monitorable and operable range for each operator and the gateway means restricts the simulation range of the control unit based on a definition in the security database.

3. The apparatus for centrally monitoring and controlling plants according to claim 1, wherein the information network, the control network, the control unit, the centralized interactive unit, and the individual interactive unit are redundantized such that the control unit, the centralized interactive unit, and the individual interactive unit perform multicast transmission to all redundantized information networks and control networks and perform reception of one processing unit at a time on a first-come-first-served basis.

4. The apparatus for centrally monitoring and controlling plants according to claim 1, wherein either one of the centralized interactive unit and the individual interactive unit includes memory management means for deleting a Tag in the Tag database if no reference is made to the Tag for a particular period of time.

5. The apparatus for centrally monitoring and controlling plants according to claim 1, wherein the individual interactive unit includes as the Tag database a local Tag database for storing a Tag requested by the individual interactive unit itself and a remote Tag database for storing a Tag requested by the gateway means.

6. The apparatus for centrally monitoring and controlling plants according to the claim 1, wherein the centralized interactive unit outputs a registration request specifying a Tag required for monitoring to the individual interactive unit and the individual interactive unit stores the Tag whose registration is requested by the centralized interactive unit in a Tag list and converts and transmits the state quantity of the Tag stored in the Tag list by the gateway means in accordance with the format of the centralized interactive unit.

7. The apparatus for centrally monitoring and controlling plants according to claim 6, wherein the centralized interactive unit outputs a request for updating Tag information in the control unit to the individual interactive unit, the individual interactive unit transmits the Tag information in the control unit whose updating is requested by the centralized interactive unit, and the centralized interactive unit adds a unique identification ID to the received Tag information and stores the Tag information in accordance with the format of the centralized interactive unit.

8. The apparatus for centrally monitoring and controlling plants according to claim 1, wherein a GW unit in place of the individual interactive unit includes only a transmission function equivalent to the control unit for the centralized interactive unit.

9. A method for centrally monitoring and controlling a plurality of plants with an apparatus for centrally monitoring and controlling plants, the apparatus including a centralized interactive unit for monitoring and controlling the operation of a plurality of plants; an individual interactive unit for monitoring and controlling a plant; an information network for connecting the centralized interactive unit and the individual interactive unit; a control unit for controlling a plant; a control network for connecting the control unit and the individual interactive unit; and gateway means which is disposed in the individual interactive unit and includes a transmission function equivalent to the control unit from the viewpoint of the individual interactive unit,
wherein the control unit carries outs the steps of inputting a state quantity of a plant as a Tag into a Tag database; multicasting a significant change in the state quantity of the plant to the control network or multicasting a “heartbeat” indicating the integrity thereof to the control network if there is no significant change in the state quantity of the plant; and returning the content of the Tag database in response to a query about the state quantity input from the control network and updating the content of the Tag database in response to an operation,
wherein the individual interactive unit carries outs includes the steps of displaying the state quantity of a Tag on an interactive screen of a plant if the Tag defined on the interactive screen exists in the Tag database of the individual interactive unit itself; multicasting a query about the state quantity to the control network if the Tag defined on the interactive screen does not exist in the Tag database of the individual interactive unit itself and registering a response from the control unit in the Tag database for update; and setting a Tag included in the control unit as defective if a “heartbeat” indicating the integrity of the control unit is not received from the control unit for a particular period of time, and
wherein the centralized interactive unit carries out the steps of displaying the state quantity of a Tag on an interactive screen of a plant if the Tag defined on the interactive screen exists in the Tag database of the centralized interactive unit itself; multicasting a query about the state quantity to the control network via the information network and the gateway means if the Tag defined on the interactive screen does not exist in the Tag database of the centralized interactive unit itself and registering a response from the control unit in the Tag database for update; and setting a Tag included in the control unit as defective if a “heartbeat” indicating the integrity of the control unit is not received from the control unit for a particular period of time.
